(19) United States
(12) Patent Application Publication
(10) Pub. No.: US 2026/0056318 A1
(43) Pub. Date: Feb. 26, 2026

(54) Methods And Systems For Intelligent Surround Sensing And LiDAR Systems Therefrom

(71) Applicant: Hamid Hatami-Hanza, Thornhill (CA)

(72) Inventor: Hamid Hatami-Hanza, Thornhill (CA)

(21) Appl. No.: 19/359,677

(22) Filed: Oct. 15, 2025

Related U.S. Application Data
(63) Continuation-in-part of application No. 17/574,263.
(60) Provisional application No. 62/876,753, filed on Jul. 21, 2019.
(60) Provisional application No. 63/708,716, filed on Oct. 17, 2024.

(51) Int. Cl. G01S 17/89; G01S 7/481; G01S 7/4865; G01S 13/86; G01S 17/93

(52) U.S. Cl. CPC G01S 17/89; G01S 7/4815; G01S 7/4818; G01S 7/4865; G01S 13/865; G01S 17/93

(57) ABSTRACT

Remote sensing systems, electromagnetic wave radiating/irradiating apertures, one or more radiating/irradiating waveguide configurations, one or more illuminating modules, directional and/or omnidirectional optical modules for collecting electromagnetic waves reflected from distal objects, detection modules/systems, signaling schemes, intelligent data processing methods and algorithms, and several light detection and ranging (LiDAR) systems with various modes of operations are disclosed. In one aspect, methods for forming one or two dimensional array/s of radiating/irradiating waveguide apertures along with associated and resulting signaling methods are also disclosed. Methods and architectures are also given for continues radiation and continues scanning of the environment. Several illumination modules with different architectures and fabrications methods and principles of operations are introduced. Remote sensing system signals also disclosed in which the illuminating signal is changing its frequency as it propagates through an illuminating and guiding medium so as to have a novel types of Frequency Varying type LiDAR.

### CROSS-REFERENCE TO RELATED MATERIALS

This application claims the benefit of U.S. Provisional Application No. 63/708,716, filed on Oct. 17, 2024 entitled “Methods And Systems For Intelligent Surround Sensing And LiDAR Systems Therefrom”, the entire contents of which are incorporated by reference herein.

This application also cross-references the co-pending US patent application entitled “Methods And Systems for State navigation” filed on Jan. 12, 2022, Application Ser. No. 17/574,263, Pub. No. US 2022/0245109, which is incorporated here as reference in its entirety.

### FIELD OF INVENTION

This invention generally relates to sensors, and more specifically to ranging and detection of objects by electromagnetic waves and signals and further is related to information processing, knowledge discovery, artificial general intelligence, and in one aspect relates to autonomous mobile systems and machines such as vehicles, robots, and transportations systems, and yet more specifically is related to RADAR/LiDAR technologies.

### BACKGROUND OF THE INVENTION

Remote sensing in general and detection and ranging in particular are important components of many modern machines and systems, such as robots and autonomous machines.

With the recent advent of artificial intelligence and the resulting applications therefrom, systems with broader intelligent capabilities are desired.

### SUMMARY OF THE INVENTION

In the context of constructing intelligent systems of high utilities such as robotic intelligent machines, autonomous mobile machines (e.g. self-driving vehicles, airplane, trains, ships, etc.) and many other applications such as medical diagnostics and imaging, multidimensional mapping, weather predictions, and generally artificial intelligent or artificial general intelligent systems, remote sensing in general and detection and range estimation and imaging in particular are of great importance and interest.

LiDAR (Light Detection And Ranging) technology in particular is a promising technology for enabling the systems and machines to become aware of their surroundings and therefore provide enough data and extract enough knowledge about their surroundings so as to assist them on their decision makings and/or movement in the space. Having LiDAR systems with accurate, reliable and robust operations still remains a challenge. LiDAR systems operate on the principle of illuminating the UDAR system surrounding by electromagnetic waves and interpreting the returned signals/wave.

The present disclosure is to provide various methods, systems, subsystems software and hardware artifact modules, and data processing methods for remote sensing and ranging applications and more particularly for comprehension of an environment surrounding an object.

In one aspect, illumination modules are introduced to illuminate the environment surrounding an object, e.g. a vehicle, plane, etc., by electromagnetic waves (preferably in the Infra-Red (IR) optical wavelength regions). Several illumination modules with different architectures and fabrications methods and principles of operation are introduced.

In another aspect, there are provided methods on how to make or fabricate such illuminating modules. According to one exemplary embodiment of the present invention methods are given and shown on how to make such illuminating modules comprises optical guiding mediums. According to one embodiment of the present invention the illuminating module using pre-fabricated optical waveguide wherein said optical waveguide can be standard single-mode optical fiber and/or single or twin-core optical fiber and/or polarization maintaining single or multicore optical fiber, and/or optically active with one or more active core and/or microstructures optical fibers such photonic bandgap and/or photonic crystal optical fiber and the like. Furthermore, illuminating modules are given with other types of optical waveguides such as semiconductor based waveguide and the fabrication process, and/or silica/glass based, and/or semiconductor (e.g. silicon) based optical waveguide and their associated fabrication process and so on.

Provided also, are methods and system for continues illumination of the environment as a propagating beam/pulse is sweeping through the desired field of view in one or more dimensions.

In another aspect, methods and systems are provided on how to detect and sense the signals from the environment's response to the illumination act and methods of comprehending and signaling scheme.

Furthermore, there are provided method and systems for processing, interpreting, and comprehending the environment response to the illumination signals.

Yet further, there are provided methods of intelligence assisted ways of analytically reasoning about the state of the surrounding environment so as to assist a decision making module and/or a control system to act and accordingly (e.g. make a sane rational decision or issuing the most appropriate command) given the surrounding state conditions. It is to be mentioned and noticed that the disclosed method of intelligent comprehension of LiDAR's data will work for all types of UDAR technological approaches in gathering informative data from a surroundings.

Systems and methods are given to use electromagnetic waves and signals/pulses for remote sensing of objects surrounding a given object. In one aspect the present invention provides a plurality of signals from a plurality of emitting/irradiating sources. The signals themselves can compose of a train of pulses which is encoded in one or more domains (e.g. in time, amplitude, frequency/wavelength code etc.).

Accordingly, system and methods are given to use one or more master signal/pulse generators to provide a much larger number of sources each illuminating the surrounding environment and pointing to different surrounding space (e.g. having different propagation angles in a spherical coordinate). In one preferred embodiment the system uses light frequency spectrum (e.g. infrared or IR) for illuminating the environment or surrounding space and is used as a LiDAR system for ranging and detection. Said UDAR, in yet another preferred embodiments, does not need a mechanical movement and can illuminate a desired angle of views (e.g. angle of view between 0 to 360 degrees for both polar and/or azimuthal angle) without a need for moving or rotating parts.

According to another aspect of the present invention, there are provided one or more illuminating module which operate at what we call “Scanning Flash Mode of Operation” in which the illuminating module illuminates region of the surrounding space with beams of light of short time duration one spot at a time for the desired field of views and without a need for mechanical scanning or actively controlled beam steering methods (i.e. without using the steering beam methods such as Optical Phased Array, pixel array reflectors, optically dispersive elements, solid-state steering array or apparatuses). Again the illuminating module can have radiating/irradiating apertures at discrete locations along the guiding medium or radiate/irradiates optical signals continuously as it traveling along the path of the guiding medium of the illuminating module.

Disclosed, further, a LiDAR system which uses a single or encoded pulses (e.g. Pulse Position Code) generated from a master light source (e.g. a fiber laser operating in IR band, or soliton pulse generator) in conjunction with delay lines to illuminate the environment at different angles and at different times to form a train of UDAR signals wherein one or more light detecting devices are used to gather the reflected signals from the remote object located at various locations (angles) at different time of illumination. The reflected LiDAR data/signals are then sensed and recorded by a signal comprehension module to decipher the information contained in the reflected LiDAR signals.

The comprehension module comprises hardware and software artifact to enable the system to provide an image of environment in one, two, or three dimensions and in some embodiments with the information about the velocity of surrounding objects.

In one aspect, according to present disclosure, methods are given to illuminate the surrounds with train of electromagnetic pulses encapsulated in one or more pre-specified time frames. In one exemplary embodiment, or example, a burst of short optical pulses (e.g. 2-100 Picosecond long pulse) placed in a periodical time window, which is in turn placed in a predetermined cycle time frame

In one aspect methods are given to cost effectively construct a LiDAR system that can produce such pre-specified pulses in the predetermine time frame by propagating the electromagnetic pulses through a coiled waveguide which is its propagating properties have been altered at predetermined places along the waveguide.

In one exemplary embodiment, the LiDAR systems uses short optical pulses (e.g., 2-100 ps) through an optical fiber/waveguide length coiled around a supporting structure (e.g. a glass tube, a sphere, cylinder, a pole etc.) configured to have one or more apertures at predetermined locations of the fiber/waveguide. Said apertures are configured to provide a mechanism by which the confined propagating light beam inside the fiber optic will have an opportunity to radiate/irradiate away and leaking some energy of a guided beam of light into the space at the designated locations so as to provide a plurality of light beam sources. When the guided beam is modulated in time (i.e. non-continues wave, or pulses) the irradiating beams also forms a train of pulses flying the LiDAR at pre-specified time (exact time of flight) to provide an accurate time of flight in addition to direction of the irradiated beams for range detection. In another embodiment, the irradiating section of the optical guiding medium is continues causing for continues illumination of the environment as a propagating beam/pulse is sweeping through the desired field of view in one or more dimensions. Accordingly, the illuminating modules, either in the form of discrete radiating/irradiating apertures or continues irradiation, illuminate the surroundings in both field of view dimension one spot at time and as the beam is propagating through the illuminating module.

In another aspect, according to the present invention, the LiDAR signals at the time of flight will have known coordinate (e.g. know azimuthal and polar angles as well as radial distance the spherical coordinate) along with other parameters such as time, frequency, amplitude, and polarization.

Therefore several properties of flying pulse at the pre-located/prefabricated apertures or propagation path of the guided beam inside the guiding medium of the illumination module, are set and known at the time of flight which make it advantages when processing the return signals/wave and gather extra information and therefore generating a better comprehension of the surrounding of the LiDAR system

To increase the accuracy and resolution of data acquisition and the final environment data, the less need for mechanical movement of and less controlling signal the more predictable, reliable, and robust the operation of the LiDAR system in faithfully sensing the environment and the surrounding objects.

The returned LiDAR signal/s being converted to digital format will form a set of data which we consider here a body of data (or more specifically a body of UDAR data) or in general a body of knowledge (because the LiDAR data-set will carry the information and hence the knowledge about the surroundings of one or more LiDAR system).

According to one embedment of the present invention the echoed portions of the LiDAR transmitted (i.e. the illuminated) from the environment is collected by an optical module which can be directional or omnidirectional and also is sensed or detected by a single or an array of optical photosensitive devices that convert the optical intensity/energy into electrical current/s is/are then amplified and/or converted to digital signal by ADC (Analogue to Digital Convertor) circuitry into one or more stream of time series digital data corresponding to the electrical current of said one or more photosensitive devices. Said detected data, from one or more photosensitive devices, then are going to be gathered, and passed to one or more data processing unit for intelligent processing so as to provide the information and knowledge about the surroundings to other desired units or modules such as control module/unit, visualization module/unit, navigation module/unit and the like.

In the US patent application, with application Ser. No. 17/574,263, entitled “Methods and System for State Navigation” a theory and a computational framework was put forward in which enables an artesian to investigate any body of data and gain or extract/obtain various types of knowledge from that body of data. In the above mentioned (U.S. patent application Ser. No. 17/574,263) disclosure, using the participation information of one more sets of lower order (state components) SCs into one more sets of the same or higher order SCs, the present invention provide a unified method and process of investigating the compositions of state components, modeling an unknown system, and obtaining as much worthwhile information and knowledge as possible about the system or the composition or the body of knowledge. The obtained knowledge and the derivatives data objects from the body of knowledge or the composition state components then are used in various embodiments to yield practical knowledgeable systems which, for example, can navigate and project through state spaces

Accordingly, exemplary methods therefore given oh how to interpret the data (e.g. the data points in the low or higher dimensional space) as state components of a system (the LiDAR system in this instance) and how assign state component (SC) order to various group of the LiDAR data from which to construct one or more states of state components each set assigned with different order and how to further construct participation matrices indicative of participation of data points in lower order (data points of an lower demission space) into the state components of higher or the same order.

Accordingly, in yet another aspect of the invention various measure of the “associational novelty value significances” are given for evaluating novelty value significance in relation to one or more target state components of the composition or the body of knowledge.

Accordingly, in yet another aspect of the invention various measure of the “associational novelty value significances” are given for evaluating novelty value significance in relation to one or more target state components of the composition or the body of knowledge.

In another aspect, according to preferred embodiment there is provided a LiDAR system that can scan 360° azimuth with large range of radial angle without a need for moving part or rotating motors or mechanical movement (

Further the LiDAR is using all optical passive (or active element to provide illuminating pulses at precise preferred time (i.e. predicable time of flight)

And in one embodiment uses optical fiber mostly, and most of the processing of LiDAR returned signals is done in optical domain with passive elements.

In yet another aspect, systems, methods of illumination, and detection and interpretation of a remote sensing system signals also disclosed in which the illuminating signal is changing its frequency as it propagates through an illuminating and guiding medium so as to have a novel types of frequency varying pulse type LiDAR (herein called FVP LiDAR) wherein in the transmitted signal is illuminating different regions of the surrounding environment as it propagate through a guiding medium. Accordingly, in one embodiment, a LiDAR system is configured by sending a frequency chirped scanning illuminating signals into the surrounding space wherein the resulting LiDAR system therefore does not need moving scanning part/s.

It is again to be mentioned that the intelligent data processing and investigation described above is agnostic to the type of technology used by a remote sensing system such a LiDAR system in how it gathers the informative data from the surroundings. In other words the methods of intelligent processing and ways of handling, formulating, building data objects from the raw data gathered by sensing systems and devices, and manipulating such data objects to obtain the knowledge about the environment or surrounds is applicable to all types LiDAR systems even with different technology and approaches in gathering environmental data.

The whole disclosed system, besides being much more reliable for not using mechanical scanning or fancy beam steering with limited steering view, along with the methods of the intelligent investigation employing state navigation framework make the decisions and the comprehension of the surrounding more reliable as the gathered data is not limited by the range of the LiDAR (as the range limits the speed at which the data can be acquired from environment).

And further a LiDAR system that can infer a causal association between the data points of LiDAR's data set and help to detect the relationships between moving objects surrounding the LiDAR system which would be the genesis of a system to become able to comprehend its environment and predict the behavior of the objects surrounding the LiDAR system (hence one more step to real intelligent machines that are aware of the surroundings).

Further through investigating various types of association between returned signals, and/or between returned signals and illuminating signals, at different time and different detectors to better recognize the environment. Further such collected data sets can be used to extract the real knowledge about how likely is the moving objects behave in various environment (hence a much more valuable set of data to be used by corresponding processing systems (introduced in the disclosed and the reference incorporated herein).

In summary, according to one preferred embodiment of the current disclosure, there is provided a LiDAR system that can scan 360 azimuth with radial angle without a need for moving part or rotating motors.

Further, the LiDAR is using all electrically Passive element to provide illuminating pulses at precise predefined time of flying (predictable time of flights), and in one embodiment uses optical fibers mostly and further most of the processing of LiDAR returned signals is done in optical domain with passive elements (such as fiber, lenses, collimators, erc0

And uses a limited number of detectors to detect 360 degrees scanning view.

And a LiDAR data processing methods and algorithms with enhanced knowledge extractions from the collected LiDAR system (i.e., e.g., the LiDAR data set).

To recap some of the key features, novelties and teachings of the present invention can be listed in a non-exhaustive list. In this disclosure through several exemplary embodiments methods, components, modules, intelligent data processing methods and artifacts, and several exemplary embodiments of LiDAR systems are disclosed, comprising
short optical pulse sources and methods of producing them,
methods and embodiments to illuminate the surrounding environment through optical waveguide apertures,
methods and embodiments to create illuminating aperture/s over a length of optical beam guiding medium (e.g. such as optical fibers of various type and structures and/or optical waveguide of various technologies such as ion exchange, sol-gel, polymeric based waveguides, and silicon photonics waveguide, etc.)
methods and embodiments for detecting returned signal from distal objects,
methods and apparatuses to collected returned signals,
methods and systems for detecting and reading the returned signal by a one or more detector system wherein each detector system can comprise one or more optical detector devices on a surface (e.g. one or more SiPM or APD mounted or fabricated over a wafer)
methods and systems of signaling and pulse coding and packet framing of illuminating optical signals (e.g. optical pulse coded packet, optical pulse train, precise timing of optical pulse signaling codes and frames along one or more scanning cycle/s)
methods and system for continues illumination of the environment as a propagating beam/pulse is sweeping through the desired field of view in one or more dimensions,
the high-speed (e.g. microwave range) electronic system to control and/or electrical pulse shaping and/or modulating light sources and/or generally to initiate/trigger signaling at the desired time/s with the desired reputation rate,
the high-speed (e.g. microwave range) electronic system to control read and digitize the returned signals at the desired time/s (data acquisition at the desired time and convert it to digital format to pass it to one or more data processing device or units and or over the communication network channels).
methods and system/s for processing returned signals through the disclosed method of building data objects (e.g. participation matric/s) from which various association strength measures are calculated between the defined state components of interest of the LiDAR operation time interval/s,
methods and system of intelligently interpreting the returned register or recorded returned signals in order to recognize and detect an investigate the objects of surrounding a LiDAR system and possible further investigation and recognitions with the added state component (e.g. the weather condition, text, and supplementary data from other sources) to the intelligent investigator of state component,
methods, systems for Furthermore systems, methods of illumination, and detection and interpretation of a remote sensing system signals also disclosed in which the illuminating signal is changing its frequency as it propagates through an illuminating and guiding medium so as to have a novel types of Frequency Varying LiDAR wherein in the transmitted signal is illuminating different regions of the surrounding environment as it propagate through a guiding medium. Accordingly, in one embayment's, a LiDAR system is configured by sending a frequency chirped scanning illuminating into the surrounding space, The resulting LiDAR system therefore does not need moving scanning part.

Many other applications and features can be found in the present disclosure, deduced, inferred, and/or envision by those skilled in the art without departing from the scope and sprit of the present disclosure and its teachings.

### BRIEF DESCRIPTION OF THE DRAWINGS

FIG. 1: Shows one exemplary general Block diagram of a LiDAR system according to one exemplary embodiment of the presenting invention according to one exemplary embodiment of the present invention.

FIG. 2a: One exemplary method and system for producing short optical pulses according to one exemplary embodiment of the present invention.

FIG. 2b: One exemplary method and system for producing short optical pulses using external modulation and nonlinear effect (e.g. soliton effect) pulse compression

FIG. 2c: One exemplary method and system for producing short optical pulses using directly modulated laser light with or without compressor according to one exemplary embodiment of the present invention.

FIG. 3a: Schematic of one exemplary embedment of one or more illuminating beam radiator or apertures according to one exemplary embodiment of the current disclosure

FIG. 3b: One embodiment of array of radiating apertures (the cross section of the coil can be any shape in principal but in one of preferred embodiments a cylinder or sphere) according to one exemplary embodiment of the present invention.

FIG. 4a: depicts an illuminating module comprising radiating/irradiating apertures are aligned vertically with detection system (e.g. a photodetector mounted at some position)

FIG. 4b: depicts an illuminating module comprising radiating/irradiating apertures are aligned vertically with one or more photodetectors mounted close to one or more of the apertures

FIG. 4c: an illuminating module comprising radiating/irradiating apertures are aligned vertically with one or more photodetectors mounted and further comprising extra length of waveguide (e.g. optical fiber based extra delay lines made of optical fibers)

FIG. 4d: an illuminating module comprising radiating apertures are aligned vertically with collimating optics and one or more photodetectors mounted further comprising optional light collecting optics

FIG. 4e.1: an illuminating module comprising irradiating apertures are placed over a curved surface (or curved strip of substrate) the outgoing beams are propagating in different angle relative to the horizontal line

FIG. 4e.2: an illuminating module comprising irradiating apertures are aligned vertically with optics that deflect and distribute the irradiating beams into the predefined angles in the

FIG. 5a: an illuminating module comprising one embodiment of array of irradiating apertures (the cross section of the coil can be any shape in principal but in one of preferred embodiments is a cylinder or sphere) according to the present invention.

FIG. 5b: an illuminating module comprising one exemplary embodiment of an array (one or two dimensional) of radiating/irradiating apertures according to the present invention. Depicted in the FIG. 5b is one exemplary way of addressing the coordinates of a radiating/irradiating aperture and its irradiated beam therefrom.

FIG. 5c. an illuminating module comprising one embodiment of array (one or two dimensional) of radiating/irradiating apertures over a curved surface according to the present invention.

FIG. 5d. an illuminating module comprising one general exemplary embodiment of array (one or two dimensional) of radiating/irradiating apertures over a curved surface in which beam first propagate vertically and delay lines can be inserted between vertically aligned aperture arrays according to the present invention.

FIG. 5e.a: illustrate an exemplary continues irradiating waveguide (note: 5e.a could be arranged similar to FIG. 5d as well).

FIG. 5e.b depicts an exemplary cross section of such waveguide according to the present invention. Same continues radiation/irradiation can be configured for the vertical first irradiation configuration of the FIG. 5d.

FIG. 5e.c: illustrate an illuminating module comprising an exemplary continues and/or periodical irradiating coupled twin-core waveguide.

FIG. 5e.d depicts an exemplary cross section of such waveguides according to the present invention. The same guiding medium arrangement of FIG. 5e.c/5e.d can be used for both vertical scanned first embodiments of FIG. 5d and horizontally scanned first embodiments of FIG. 5c according to the present invention.

FIG. 6a. Conceptual cross sectional schematic of incident beams from radiating apertures and their reflection from an object to the detector or receiver with a transmitted according to the present invention.

FIG. 7b: Waveguide with perturbed propagating path with minimized deflection angle according to the present invention.

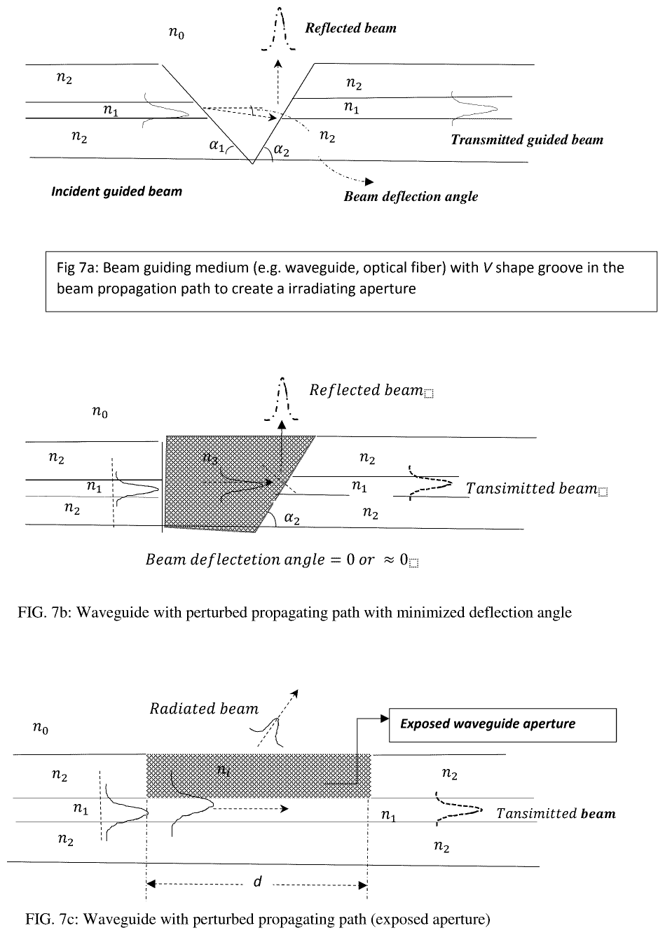

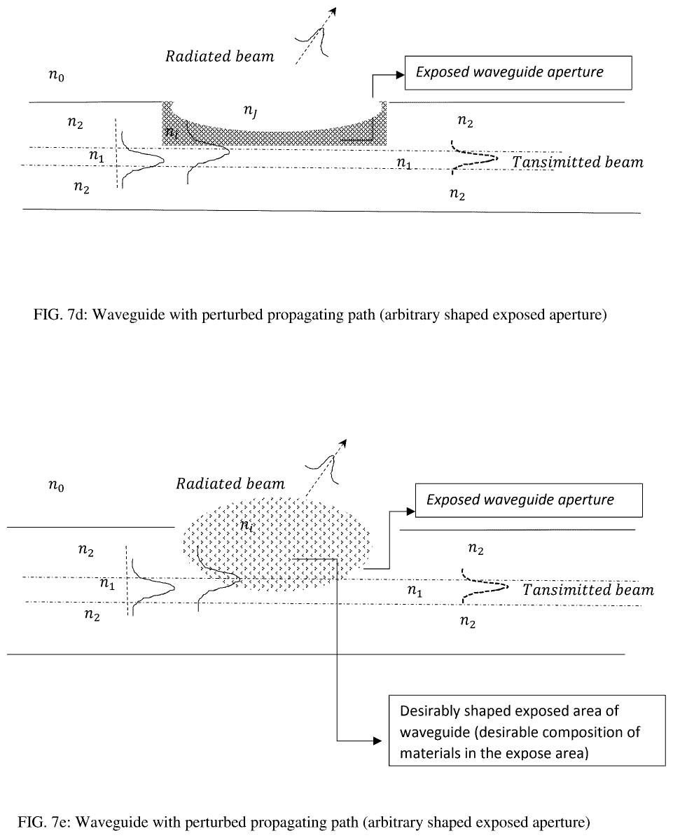

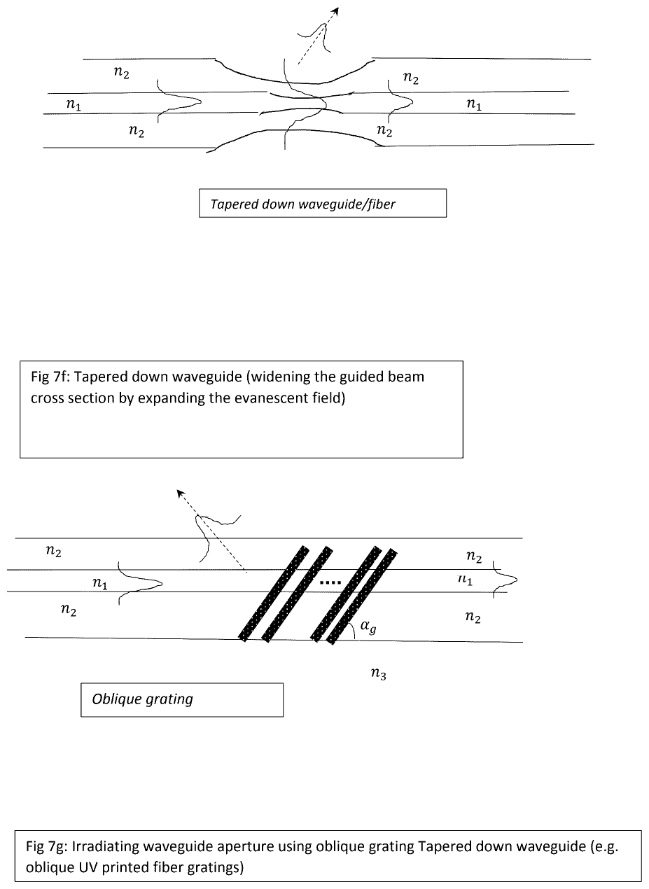

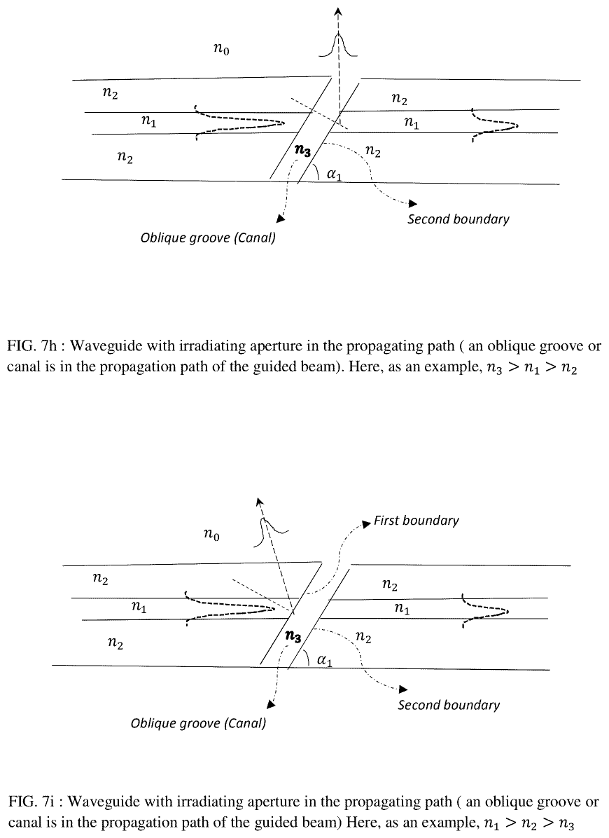

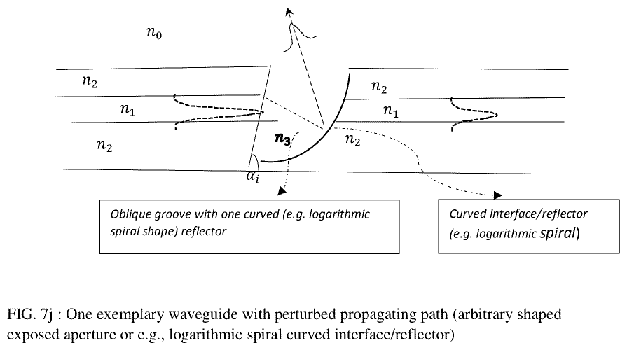

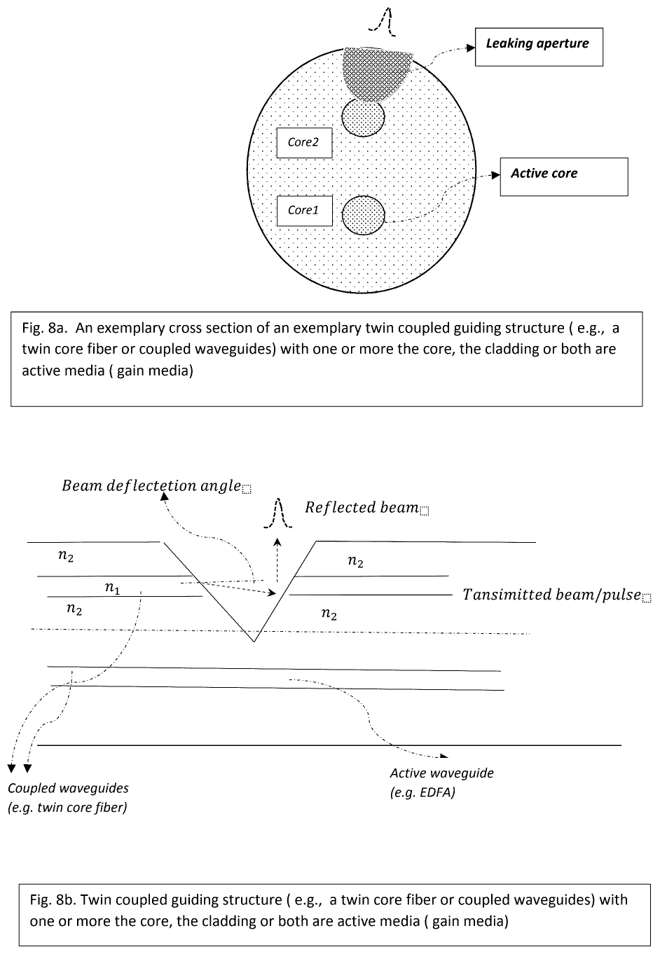

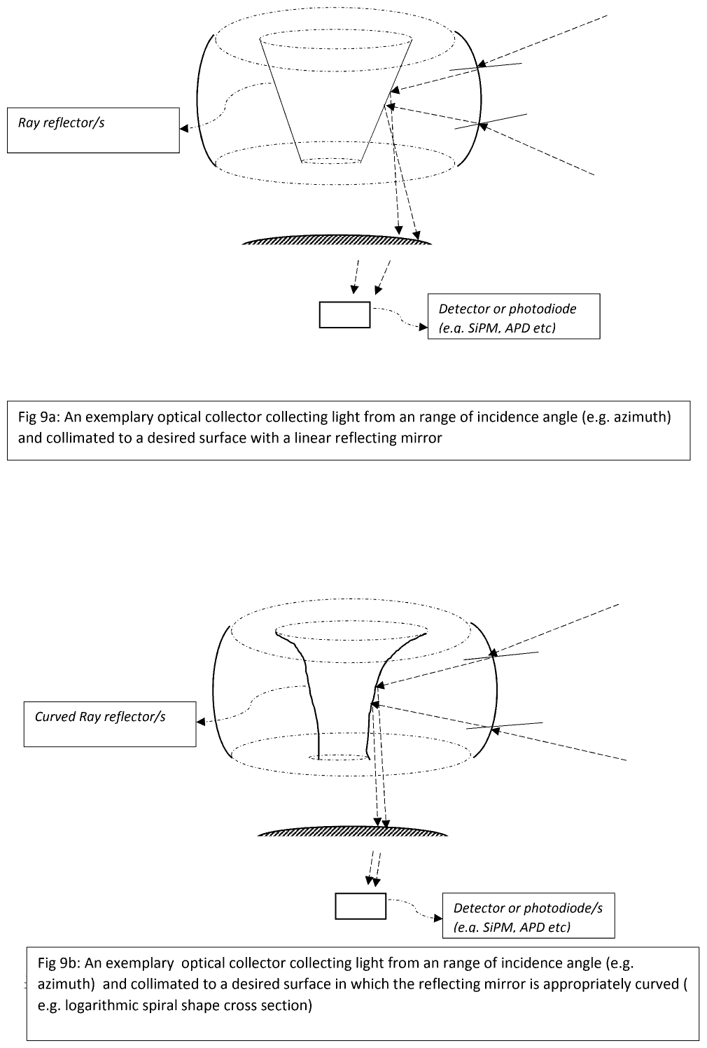

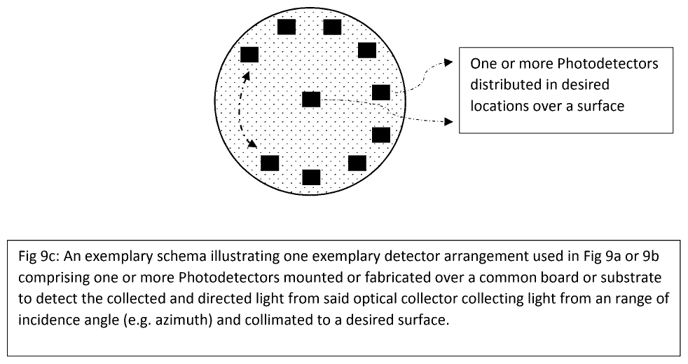

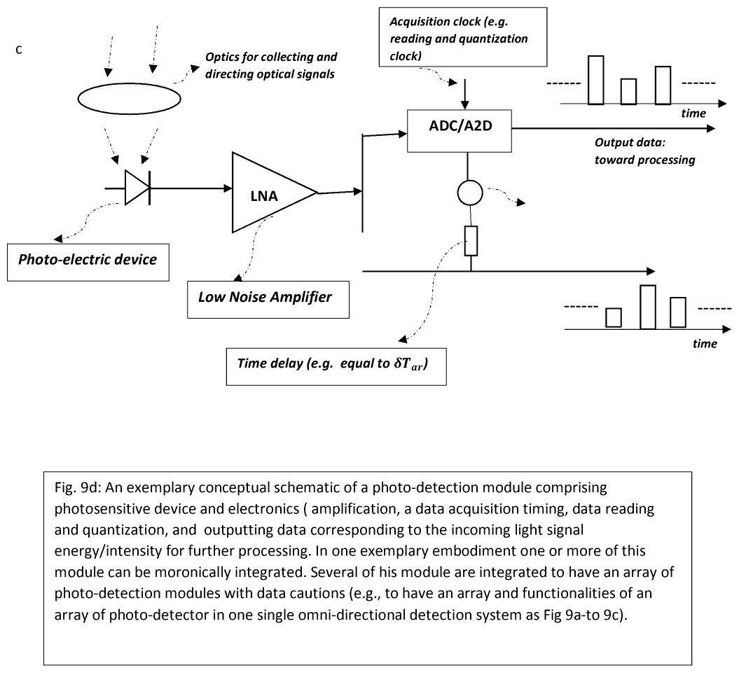

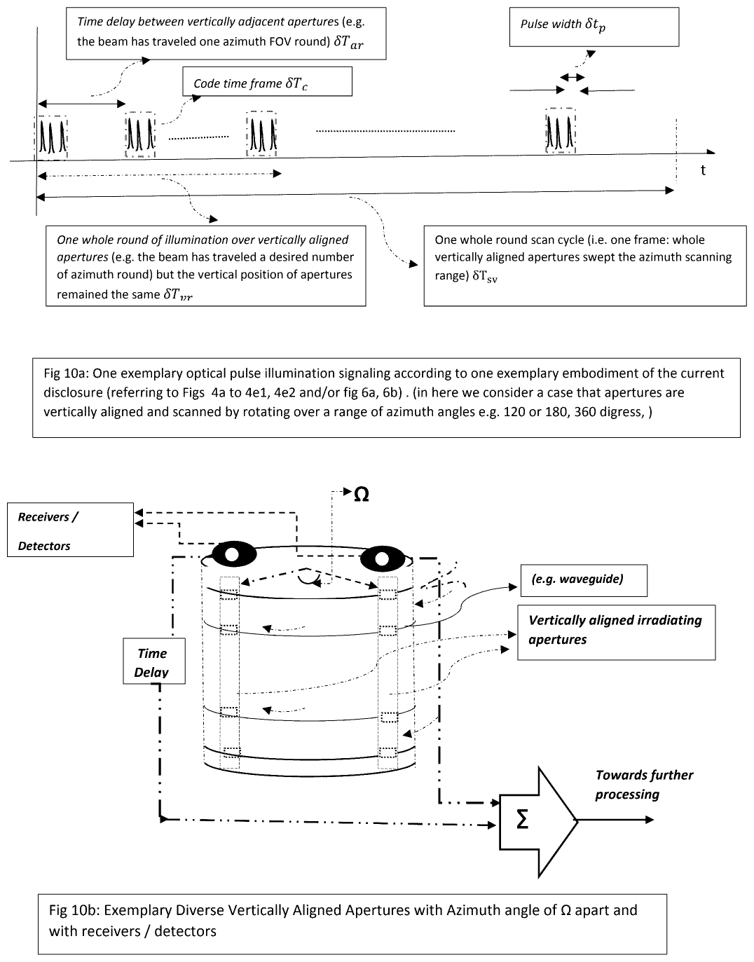

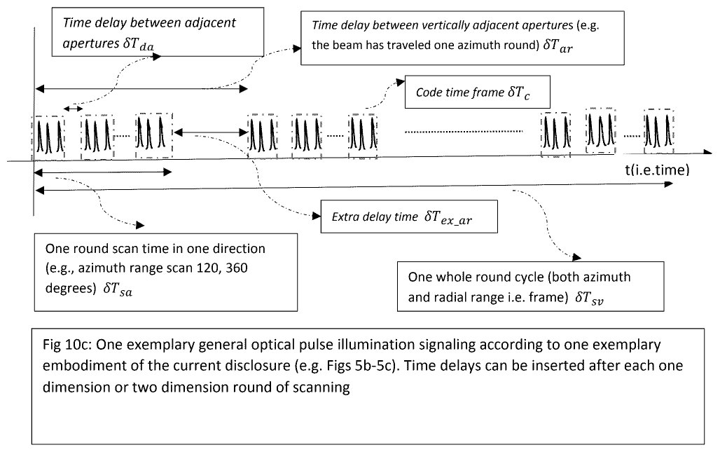

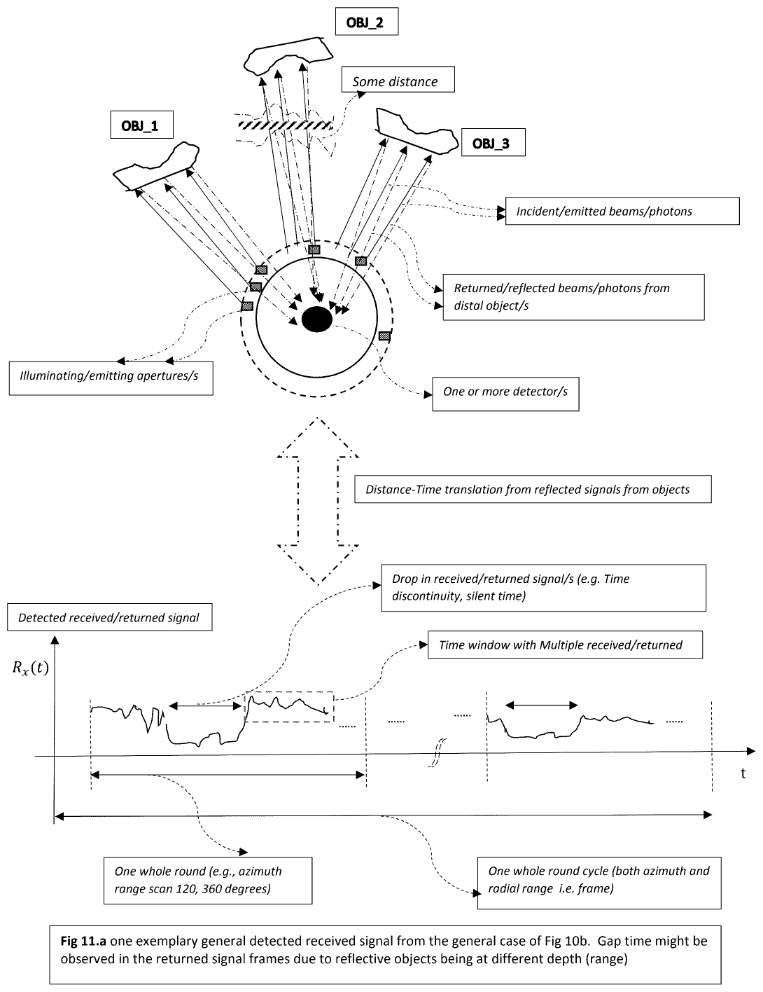

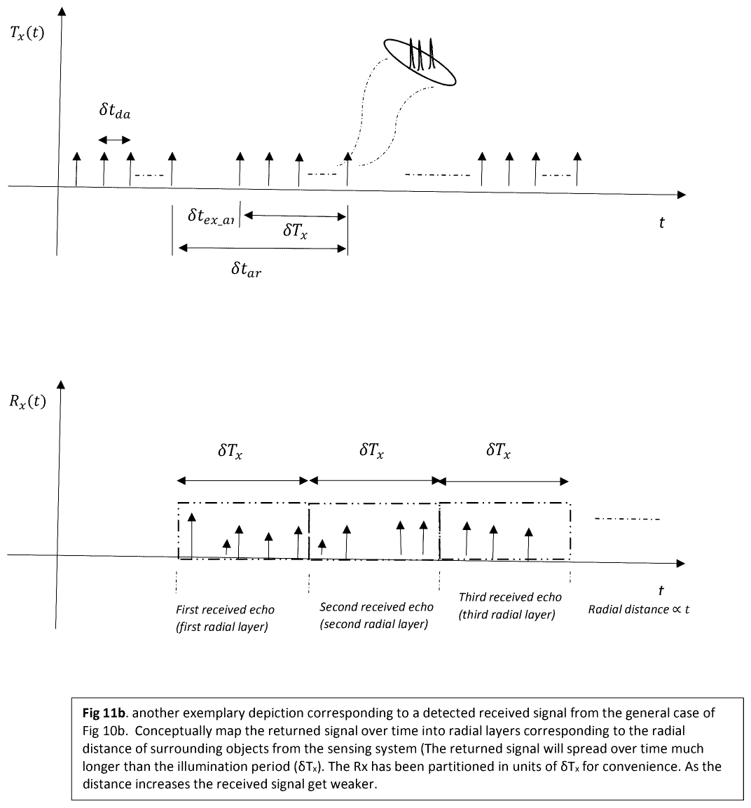

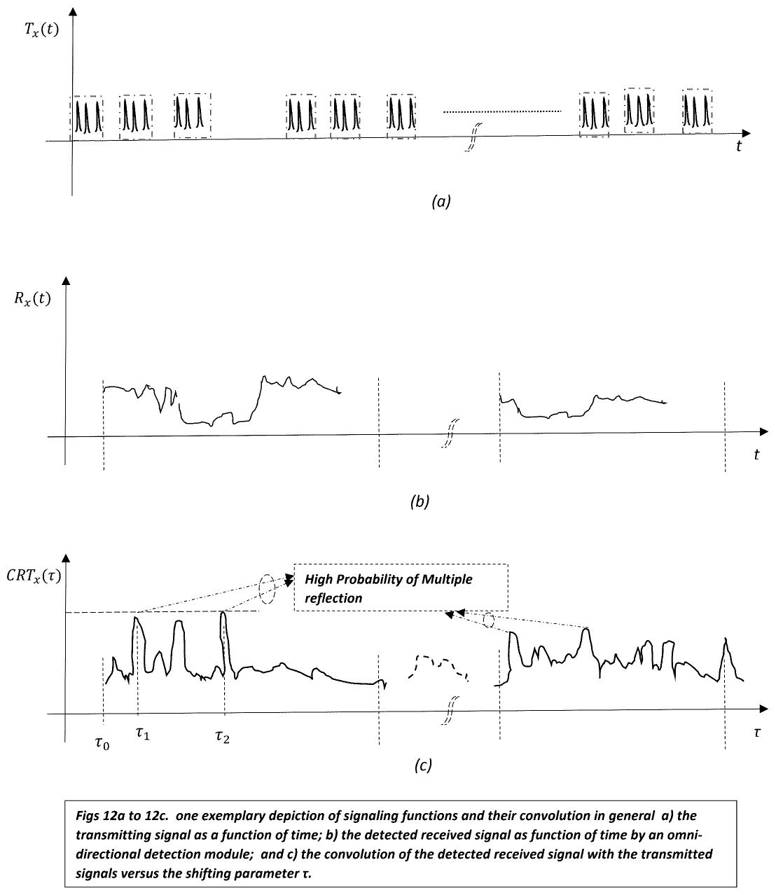

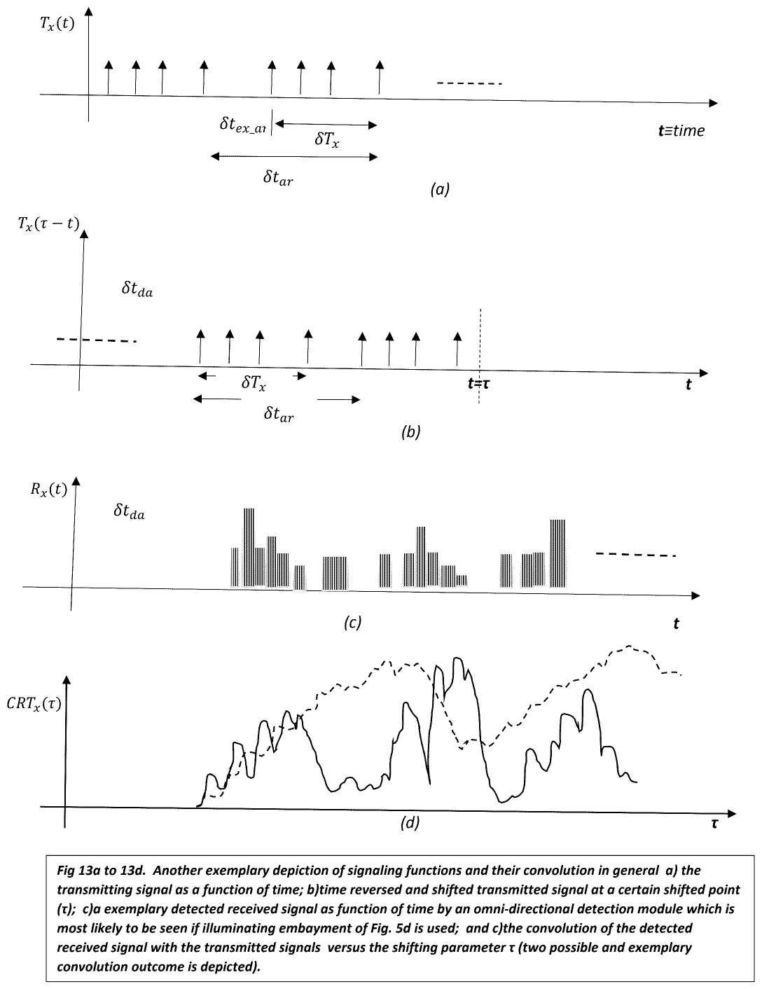

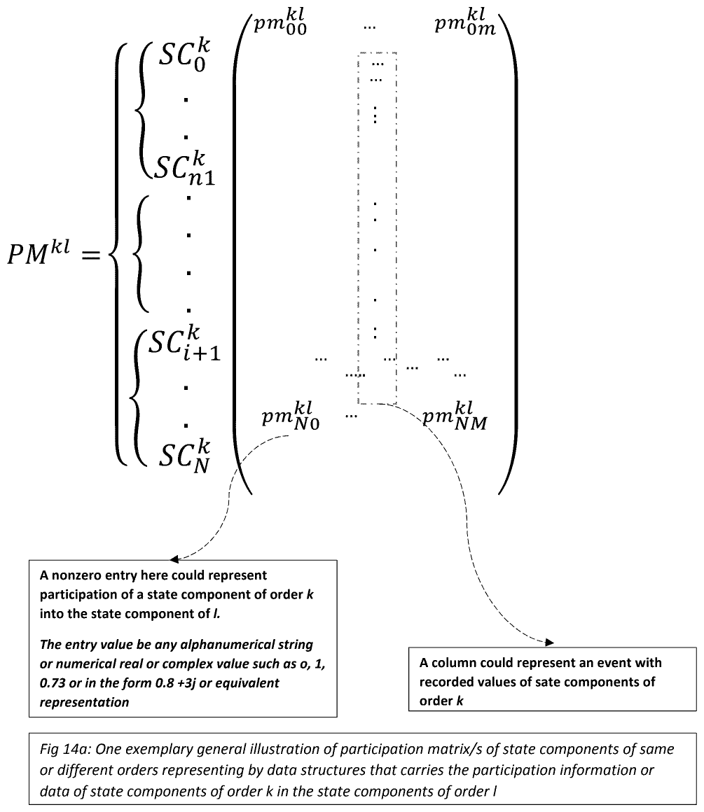

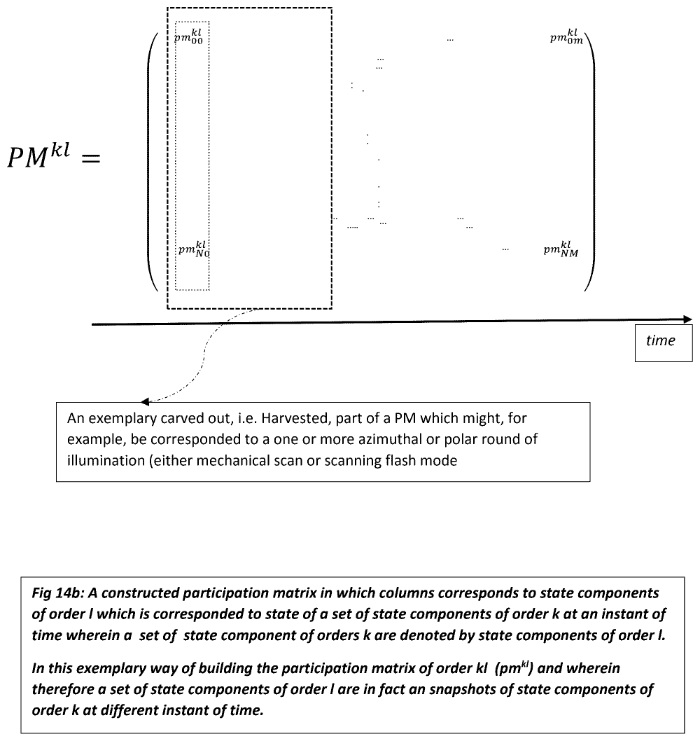

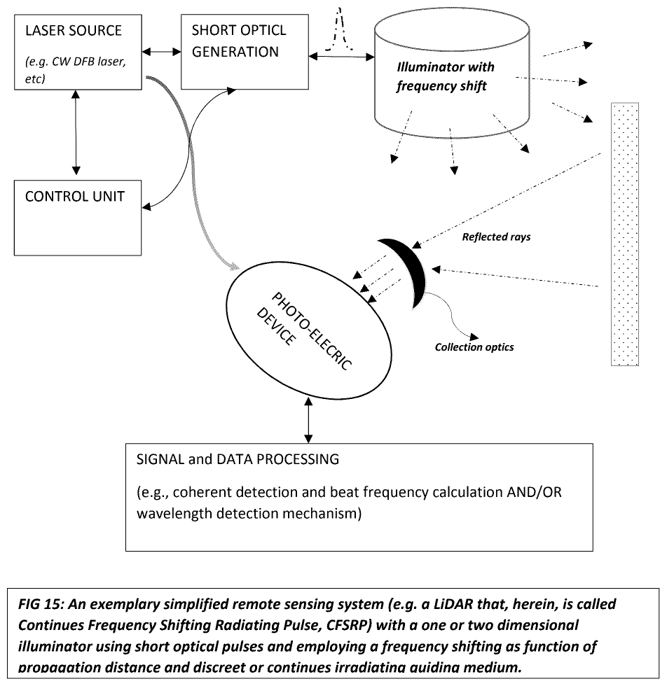

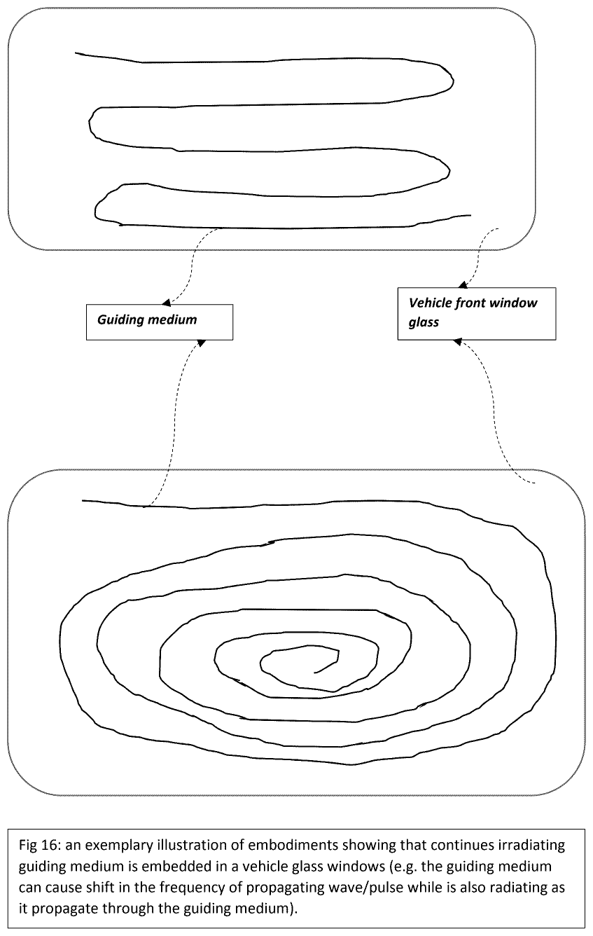

FIGS. 7a-7h shows several exemplary embodiments of irradiating waveguide apertures according to the present disclosure according to the present invention.
a. FIG. 7a: Beam guiding medium (e.g. waveguide, optical fiber) with V shape groove in the beam propagation path to create a irradiating aperture according to the present invention.
b. FIG. 7b: Waveguide with perturbed propagating path with minimized deflection angle according to the present invention.
c. FIG. 7c: Waveguide with perturbed propagating path (exposed aperture) according to the present invention.
d. FIG. 7d: Waveguide with perturbed propagating path (arbitrary shaped exposed aperture) according to the present invention.
e. FIG. 7e: Waveguide with perturbed propagating path (arbitrary shaped exposed aperture) according to the present invention.
f. FIG. 7f: Tapered down waveguide (widening the guided beam cross section by expanding the evanescent field) according to the present invention.
g. FIG. 7g: Irradiating waveguide aperture using oblique grating Tapered down waveguide (e.g. oblique UV printed fiber gratings) according to the present invention.
h. FIG. 7h: Waveguide with radiating/irradiating aperture in the propagating path (an oblique groove or canal is in the propagation path of the guided beam). Here, as an example, n₃>n₁>n₂ according to the present invention.

FIG. 7i: Waveguide with radiating/irradiating aperture in the propagating path (an oblique groove or canal is in the propagation path of the guided beam) Here, as an example, n₁>n₂>n₃ according to the present invention.

FIG. 7j: One exemplary waveguide with perturbed propagating path (arbitrary shaped exposed aperture or e.g., logarithmic spiral curved interface/reflector) according to the present invention.

FIG. 8a; An exemplary cross section of an exemplary twin coupled guiding structure (e.g., a twin core fiber or coupled waveguides) with one or more the core, the cladding or both are active media (e.g., a gain medium)

FIG. 8b: Twin coupled guiding structure (e.g., a twin core fiber or coupled waveguides) with one or more the core, the cladding or both are active media (gain media)

FIG. 9a: An exemplary optical collector collecting light from an range of incidence angle (e.g. azimuth) and collimated to a desired surface with a linear reflecting mirror according to the present invention.

FIG. 9b: An exemplary optical collector collecting light from an range of incidence angle (e.g. azimuth) and collimated to a desired surface in which the reflecting mirror is appropriately curved (e.g. logarithmic spiral shape cross section) according to the present invention.

FIG. 9c: An exemplary schema illustrating one exemplary detector arrangement used in FIG. 9a or 9b comprising one or more Photodetectors mounted or fabricated over a common board or substrate to detect the collected and directed light from said optical collector collecting light from an range of incidence angle (e.g. azimuth) and collimated to a desired surface, according to the present invention.

FIG. 9d: An exemplary conceptual schematic of a photo-detection module comprising photosensitive device and electronics (amplification, a data acquisition timing, data reading and quantization, and outputting data corresponding to the incoming light signal energy/intensity for further processing. In one exemplary embodiment one or more of this module can be moronically integrated. Several of his module are integrated to have an array of photo-detection modules with data cautions (e.g. to have an array and functionalities of an array of photo-detector in one single omni-directional detection system as FIG. 9a- to 9c).

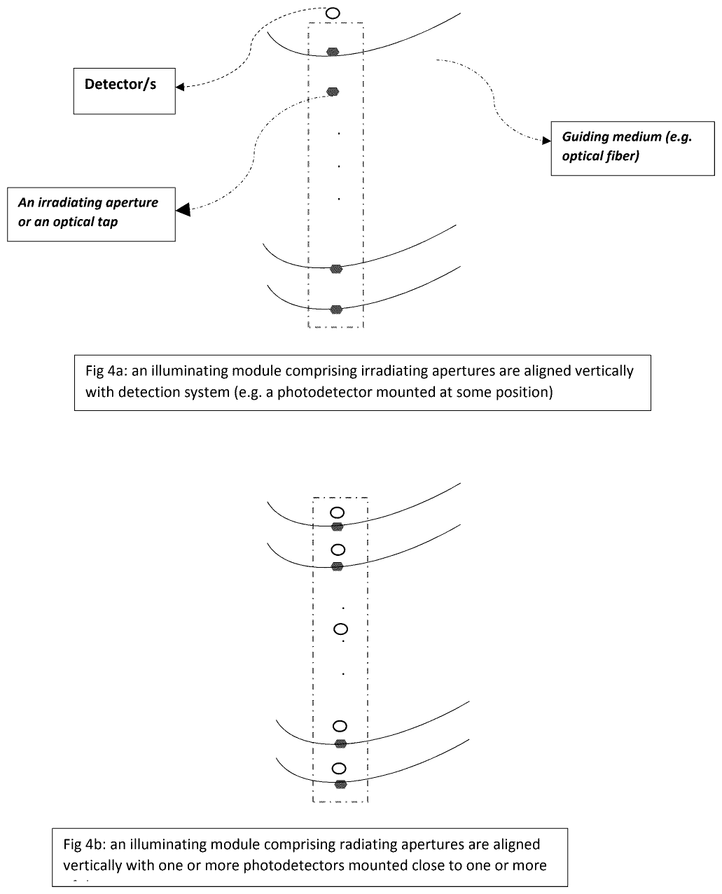

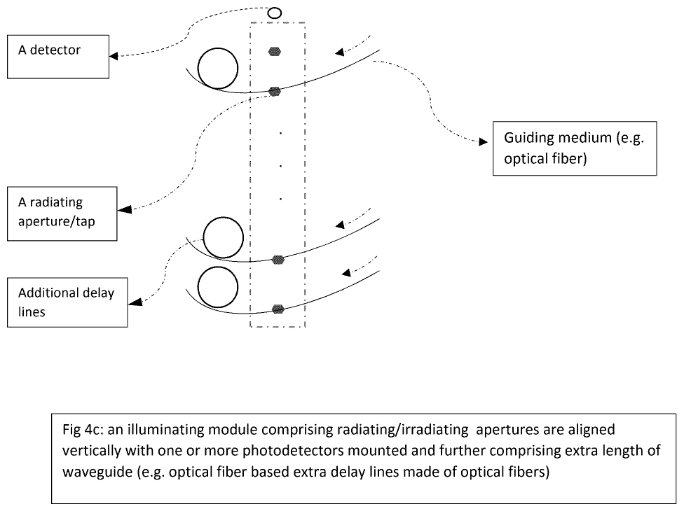

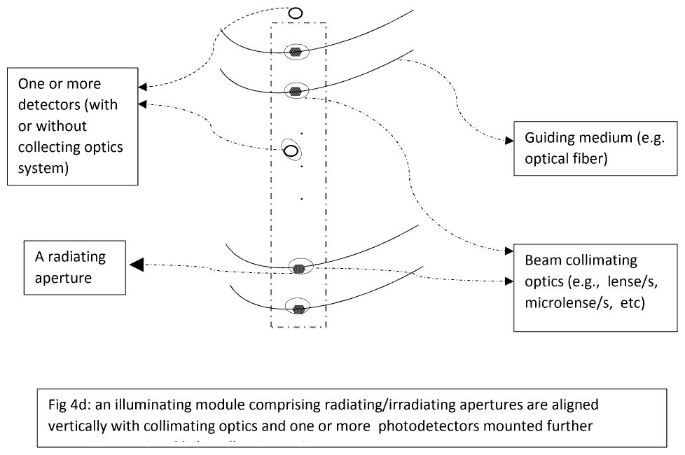

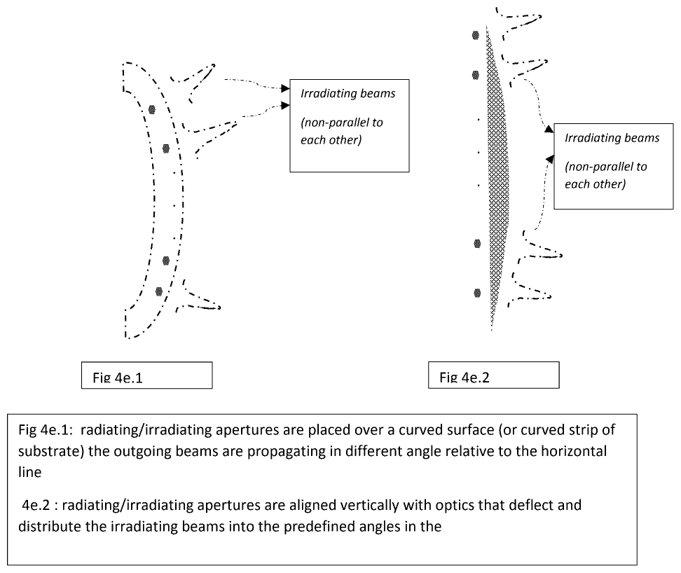

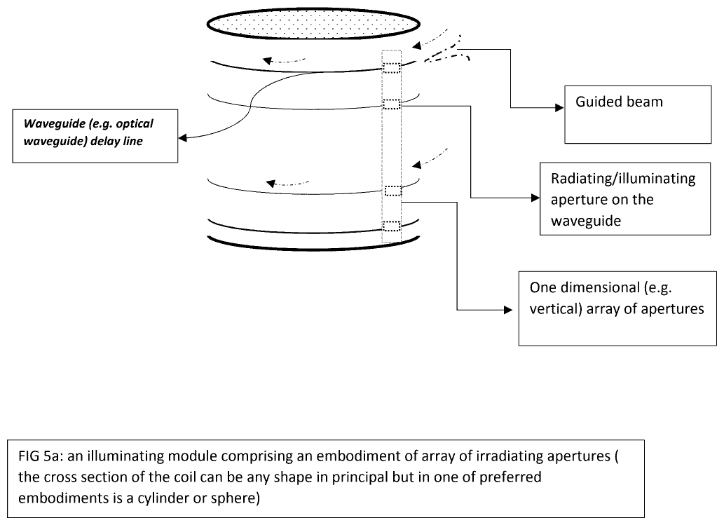

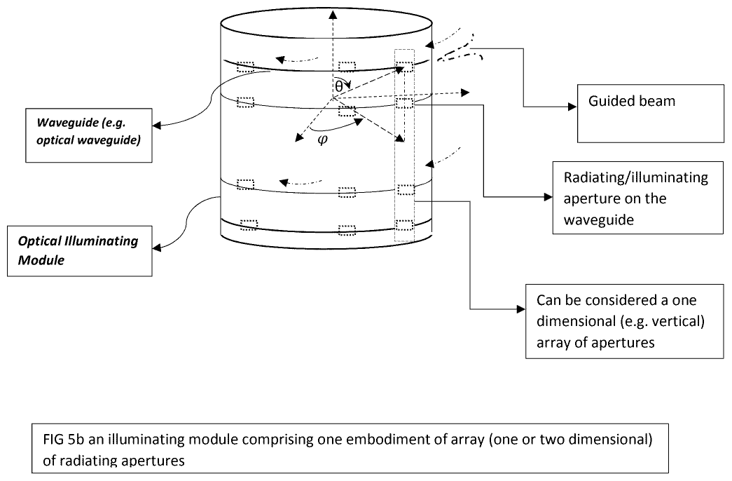

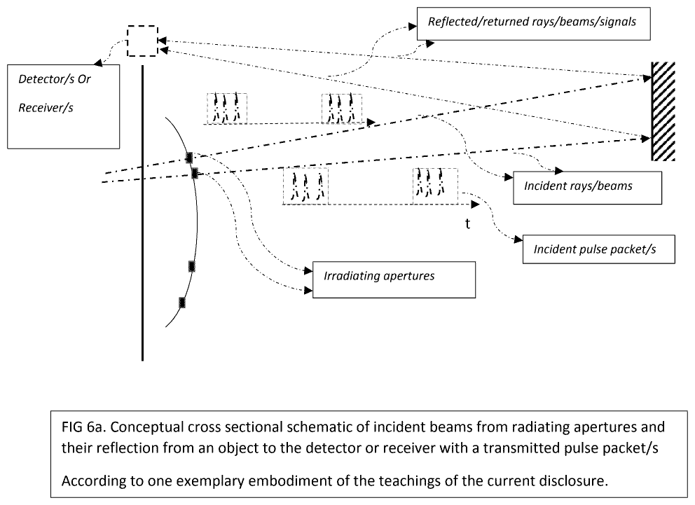

FIG. 10a: One exemplary optical pulse illumination signaling according to one exemplary embodiment of the current disclosure (referring to FIGS. 4a to 4e1, 4e2 and/or FIG. 6a, 6b). (in here we consider a case that apertures are vertically aligned and scanned by rotating over a range of azimuth angles e.g. 120 or 180, 360 digress,) according to the present invention.

FIG. 10b: One exemplary embodiment showing a “Diverse Vertically Aligned Apertures” with Azimuth angle of Ω apart and with receivers/detectors according to the present invention.

FIG. 10c: One exemplary general optical pulse illumination signaling as a function time (t) according to one exemplary embodiment of the current disclosure. Pre-specified delay can be introduced after each round of vertical illuminations (i.e. polar field of view round), horizontal illumination (azimuthal field of view round) or after both directions round (e.g., a frame) and so on according to the present inventions' disclosure.

FIG. 11a. An exemplary general detected received signal from the general case of FIG. 10b. Gap time might be observed in the returned signal frames due to reflective objects being at different depth (range) according to the present disclosure.

FIG. 11b. Another exemplary depiction corresponding to a detected received signal from the general case of FIG. 10b. Conceptually map the returned signal over time into radial layers corresponding to the radial distance of surrounding objects from the sensing system (The returned signal will spread over time much longer than the illumination period (δTₓ). The Rx has been partitioned in units of δTₓ for convenience. As the distance increases the received signal get weaker according to the present inventions' disclosure.

FIGS. 12a to 12c: One exemplary depiction of signaling functions and their convolution in general a) the transmitting signal as a function of time; b) the detected received signal as function of time by an omni-directional detection module; and c) the convolution of the detected received signal with the transmitted signals versus a time shifting parameter τ, according to on exemplary embodiment of the present inventions.

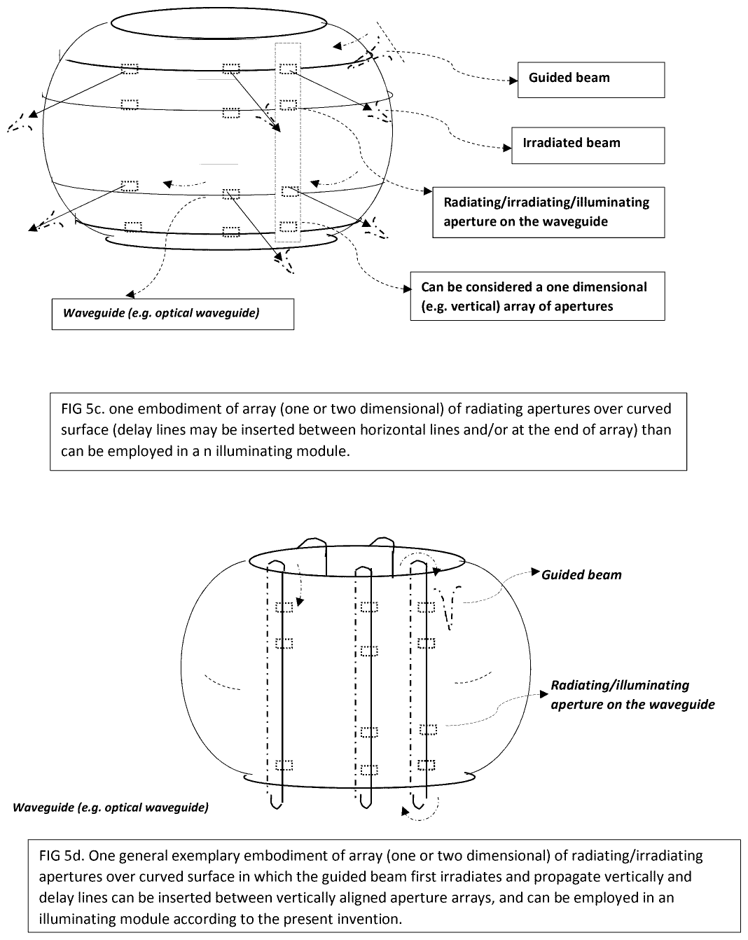

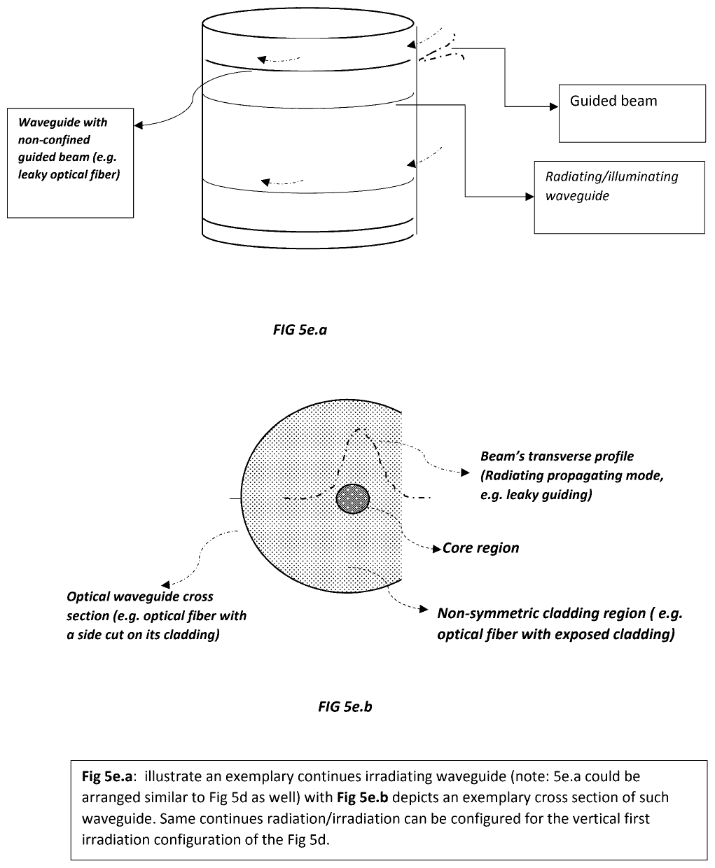

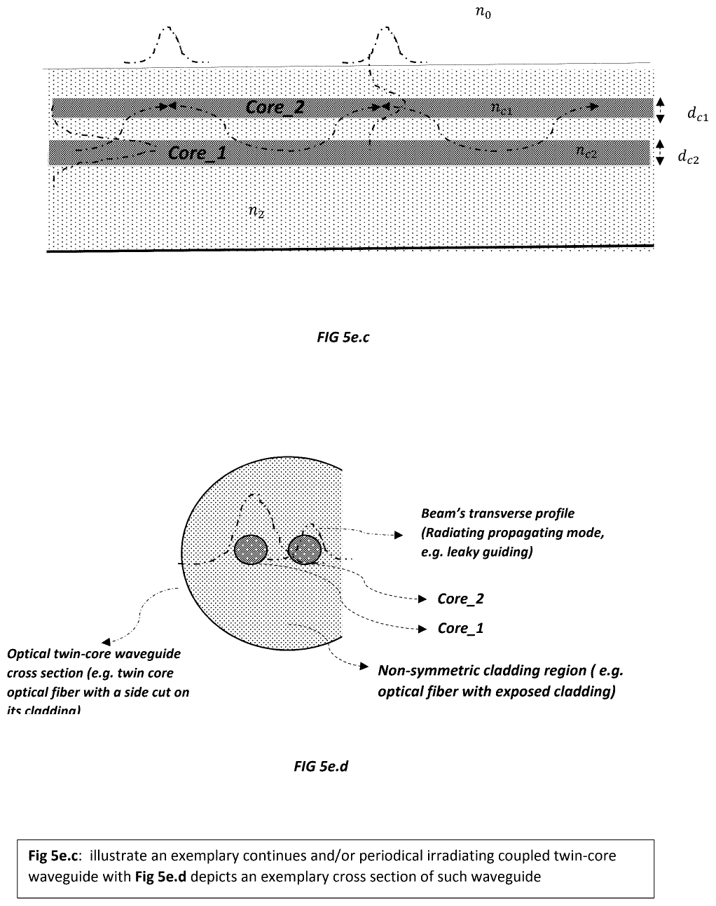

FIGS. 13a to 13d: Another exemplary depiction of signaling functions and their convolution in general a) the transmitting signal as a function of time; b) time reversed and shifted transmitted signal at a certain shifted point (t); c) a exemplary detected received signal as function of time by an omni-directional detection module which is most likely to be seen if illuminating embayment of FIG. 5d is used; and c) the convolution of the detected received signal with the transmitted signals versus the shifting parameter t (two possible and exemplary convolution outcome is depicted).

FIG. 14a: One exemplary general illustration of participation matrix/s of state components of same or different orders representing by data structures that carries the participation information or data of state components of order k in the state components of order l, according to one exemplary embodiment of the present invention disclosure. Rows are corresponded to state component of order k wherein they can be corresponded or referring to or representing to groups of state components with order k but having the same or similar attribute/s (e.g. they can represent digitized and quantized values of certain measurable variable such the output of a photosensitive detector after ADC). The participation of state component of order k in the PM^{kl} is conveniently, but not necessarily, indicated by having binary value in the corresponding entry of the PM^{kl} (e.g. an entry of

$$p {m}_{i j}^{k l}$$

in the ith row jth columns of the PM^{kj}) as being present in the state component of order l in that column (e.g. at the moment of observation whether certain value of certain measurable which have been assigned as was observed

$${SC}_{i}^{k}$$

was observed at the time of observation of states that is represented and assigned by state component order of l which is assigned with

$$S {C}_{j}^{l} ) .$$

FIG. 14b: One exemplary illustration of the building participation matrix corresponding to the participation of state components of interest into a higher order state components corresponding to the events taking place at different times (e.g. the state value of state component of first order in the set of state component at the time of sampling and/or readying the received echoes at the sampling time sampled at sampling rate speed, e.g., the highest speed at which the data is collected periodically, according to one exemplary embodiment of the present inventions' disclosure. FIG. 14b, is in other words depicts a constructed participation matrix in which columns corresponds to state components of order l which is corresponded to state of a set of state components of order k at an instant of time wherein a set of state component of orders k are denoted by state components of order l. In this exemplary way of building the participation matrix of order kl (pm^{kl}) and wherein therefore a set of state components of order l are in fact an snapshots of state components of order k at different instant of time.

FIG. 15: An exemplary simplified remote sensing system (e.g. a LiDAR) with a one or two dimensional illuminator using short optical pulses and employing a frequency shifting as the function of propagation distance and discreet or continues irradiating guiding medium.

FIG. 16: an exemplary illustration of embodiments showing that continues irradiating guiding medium in embedded in a vehicle glass windows (e.g. the guiding medium can cause shift in the frequency of propagating wave/pulse while is also radiating as it propagate through the guiding medium).

### DETAILED DESCRIPTION

Now the application and the disclosure is described by way of explaining the invention through exemplary embodiments to enable an ordinary skilled in the art to practice the techniques, the methods and the teachings of the present disclosure. It is obvious that the teachings are done by simplified instances of the invention in order to help an artisan to grasp the concepts and the inventive ideas of the present inventions/s' operations and become able to practice and implement one or more embodiments of the disclosed systems as a whole, and/or the subsystems (e.g. the high frequency RF/microwave circuitry, the optical circuit/s, and/or the optics, and/or the digital processing circuitry etc.), and/or the methods, and/or the algorithms and/or the software artifacts.

Surrounding sensing and sensing the environment and interpreting the dataset corresponding to, and/or acquired from, sensory system and devices is vital for constructing or operating intelligent and/or autonomous systems and machines. Furthermore, they have many other applications in many areas of technology and economic sectors such as agriculture, medical application, aviation, space communication etc.

In particular one technology is very promising and instrumental in building such machines is LiDAR (commonly referring to “Light Detection and Ranging”).

Current advanced LiDAR technology uses one or more arrays of light emitting sources to sense the environment.

Current LiDAR teleology, in principal, can be divides into two major approach to interpret the surrounding and more particular the geographical, size, and movement speed and direction of objects of the LiDAR:

Generally major challenges (or otherwise the task of a LiDAR system and the objectives) in designing and building reliable LiDAR systems, are:
To measure the radial distance and/or positional coordinates of a distal object and/or it's parts;
To observe a desired field of view reliably; and
To process and interpret the measured and observed data reliably, in order to comprehend and understand the observed (e.g. the surrounding) environment.
a. Currently, for measuring the range and radial distance of surrounding objects again, in general there are two major type of approaches or technologies namely:
Time of flight or TOF (e.g. observing time of flight of an emitting signal and the time of returned light at the LiDAR)
Measuring the frequency of the returned signals (i.e. the echo) from surrounding objects
   1. and comparing them with transmitted chirped optical signal (e.g. through coherent detection of mixed optical signal). This type of LiDRAs are known as Frequency Modulated Continues Wave or FMCW LiDAR's.
b. For covering the desirable range of field of views, there is a need for a mechanism to lit or illuminate the surroundings somehow. Accordingly there several approaches for illuminating the surrounding as the followings:

Scanning the surrounding and illuminate the surroundings point by point or line by line in the forms of one or two dimensional moving scanning mechanism which again can be categorized by two major scanning approach as the followings:
a. either a motorized rotation, oscillating mirrors, or rotating mirrors, and/or MEMS moving reflectors) to cover the desired field of views in both azimuthal and polar angle (we use spherical coordinates to identify objects for simplicity of explanation)
b. electronic scanning by controlling the phase of radiated beams by many laser sources (e.g. a one or two dimensional array of laser diodes) also known as phased array LiDARs.

Illuminating the desired field of views all at once by a flashing beam of light (also known as Flash LiDRAs).

Accordingly, numerous types and systems of LiDARs with various combinations of these major enabling approaches can be proposed and/or implemented with different technologies for various applications.

However, a desirable LiDAR system will have to have at least the following characteristics:
Affordable cost,
Durable,
Reliable,
Accurate, precise, with high enough resolution,
Safe to human and environment,
Wide field of view/s,
Simplified as much as possible,
Ability to sense as long distal range as possible, and
Ability to acquire extremely high volume of data from the environment when desired.

All the current technologies and implementation of LiDAR systems will have significant shortcomings in most (if not all) of these characteristics.

Current major technologies that are in use today to construct, build, process, constructing and storing point cloud data sets can be categorized or summarised in the following approaches.

Single optical illuminating source (e.g. a single laser diode with small collimated beam radius) LiDRAs require 2D mechanical scanning which arises the reliability and accuracy issues.

Mechanical rotation of a single or an array of laser source are not durable nor reliable and will lack the desired reliability or are far from ideal operation of a LiDAR system.

Microelectromechanical systems (also known as MEMS) are not durable, nor accurate to be used independently or in conjunction with technologies with rotating or scanning mirrors.

Laser diode/detector arrays (e.g., multichannel LiDRAs) are also challenging in generating short optical pulses whereas they still need at least 1D motorized scanning with limited vertical/polar resolution while also would impose challenges in synchronization and investigation of multiple channels detected signal into integrating and interpreting the returned signals information/data accurately and transforming into a desired data format (e.g. into a cloud data points).

Using integrated silicon photonics to monolithically integrating the electronic and optical sources and detectors, would be challenging in producing short optical pulses and struggle in Microwave range electronics. In addition silicon photonic cannot easily be integrated with electronics and the manufacturing process still remain a challenge. This is especially more true for the time of flight (i.e. TOF) types of LiDARs.

Optical phased array in principal is a good approach for electronically scanning light beams in the space, however theoretical and technical challenges remains for using this approach due to the fact the optical wavelengths are extremely short (in the range of few hundreds of nanometer to few micron) and therefore controlling the phase of an array of radiating sources (optical antennas) dynamically at source, and also along the path, to achieve a pensile like radiating beam (i.e., a directive pattern of radiation) is extremely challenging and not reliable at the same time.

Frequency Modulated Continues wave (i.e. known as FMCW) types LiDARs uses electromagnetic source that its frequency of radiation is changed (preferably linearly) with time and is capable of calculating the distance and towards/away speed of sounding objects by coherently mixing the returned signals from the object with the source by detecting in a nonlinear detectors (optical detectors are intensity detectors inherently and therefore are nonlinear function of electromagnetic field amplitude) and observing and/processing the resulting beat signal to estimate the distance and speed of the objects surrounding the LiDAR system. Keeping a coherence time/length of a laser source for long (i.e. having laser sources of very narrow linewidth) is extremely challenging specially if using silicon photonic fabrication processes for full integration of electronics and optical components in a single chip. This will limit the application and range of detection of FMCW type LiDRAs. Tuning the laser radiation frequency in a desirable manner (e.g. predictable and robust behaviour of the lasing frequency/wavelength of the source as a function of time) is also a challenge.

Many technical obstacle make the operation of FMCW LiDRAs challenging and not reliable, the least of which is multipath reflection from different objects and/or clutters which make the operation of FMCW far from its ideal operation (e.g., having a single coherent phased preserved reflected signal). Nevertheless, in addition, the scanning/steering challenges still remains for FMCW type LiDRAs as well.

Accordingly, improvements in one or more areas of these shortcomings are needed or desired in the field of remote sensing by irradiating the space with electromagnetic signals in general and LiDAR's technology in particular.

In this disclosure through several exemplary embodiments methods, components, modules, intelligent data processing methods and artifacts, and several exemplary embodiments of LiDAR systems are disclosed, comprising
short optical pulse sources and methods of producing them,
methods and embodiments to illuminate the surrounding environment through optical waveguide apertures,
methods and embodiments to create illuminating aperture/s or sections over a length of optical beam guiding medium (e.g. such as optical fibers of various type, designs, functionalities, and structures and/or optical waveguide of various technologies such as ion exchange, sol-gel, polymeric based waveguides, and silicon photonics waveguide, etc.)
methods and embodiments for detecting returned signal from distal objects,
methods and apparatuses to collected returned signals,
methods and systems for detecting and reading the returned signal by a one or more detector system wherein each detector system can comprise one or more optical detector devices on a surface (e.g. one or more SiPM or APD mounted or fabricated over a wafer),
methods and systems of signaling and pulse coding and packet framing of illuminating optical signals (e.g. optical pulse coded packet, optical pulse train, precise timing of optical pulse signaling codes and frames along one or more scanning cycle/s),
methods and system for continues illumination of the environment as a propagating beam/pulse is sweeping through the desired field of view in one or more dimensions,
the high-speed (e.g. microwave range) electronic system to control and/or electrical pulse shaping and/or modulating light sources and/or generally to initiate/trigger signaling at the desired time/s with the desired reputation rate,
the high-speed (e.g. microwave range) electronic system to control read and digitize the returned signals at the desired time/s (data acquisition at the desired time and convert it to digital format to pass it to one or more data processing device or units and or over the communication network channels).
methods and system/s for processing returned signals through the disclosed method of building data objects (e.g. participation matric/s) from which various association strength measures are calculated between the defined state components of interest of the LiDAR operation time interval/s,
methods and system of intelligently interpreting the returned register or recorded returned signals in order to recognize and detect an investigate the objects of surrounding a LiDAR system and possible further investigation and recognitions with the added state component (e.g. the weather condition, text, and supplementary data from other sources) to the intelligent investigator of state component,
methods, systems for Furthermore systems, methods of illumination, and detection and interpretation of a remote sensing system signals also disclosed in which the illuminating signal is changing its frequency as it propagates through an illuminating and guiding medium so as to have a novel types of Frequency Varying type LiDAR wherein in the transmitted signal is illuminating different regions of the surrounding environment as it propagate through a guiding medium. Accordingly, in one embayment's, a UDAR system is configured by sending a frequency chirped scanning illuminating into the surrounding space, The resulting LiDAR system therefore does not need moving scanning part.

### The Remote Sensing System

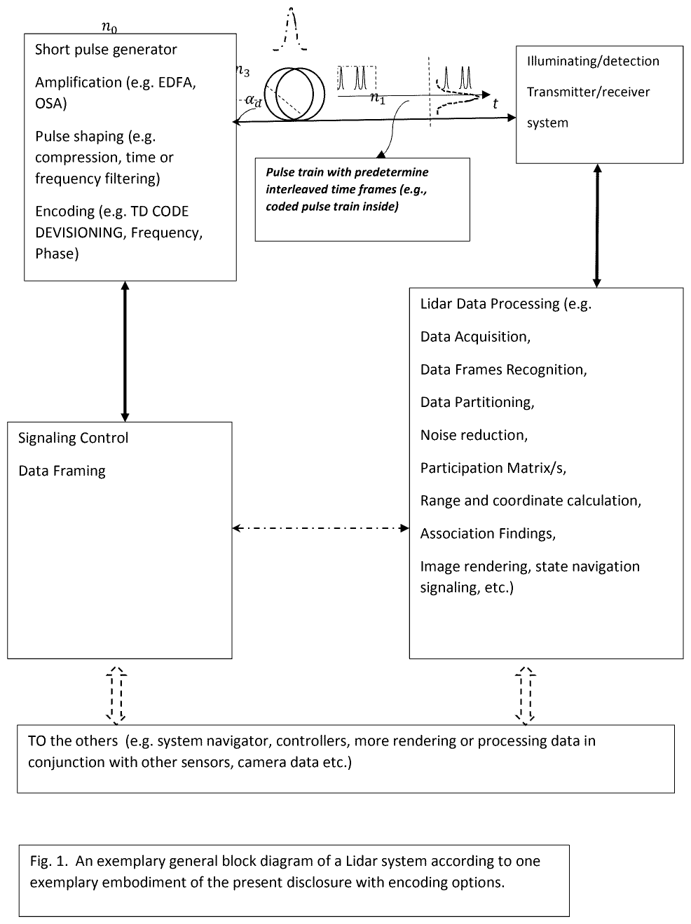

Referring to FIG. 1 now it shows a general system of a LiDAR according to the present disclosure. The system comprises an RF/mm-microwave electronic system, an optical short pulses generation system (with optical pulse coding module as option in some embodiments), an optical illuminating module or system, a detecting system or module, an acquisition system or module, a processing system or module and a control system or module.

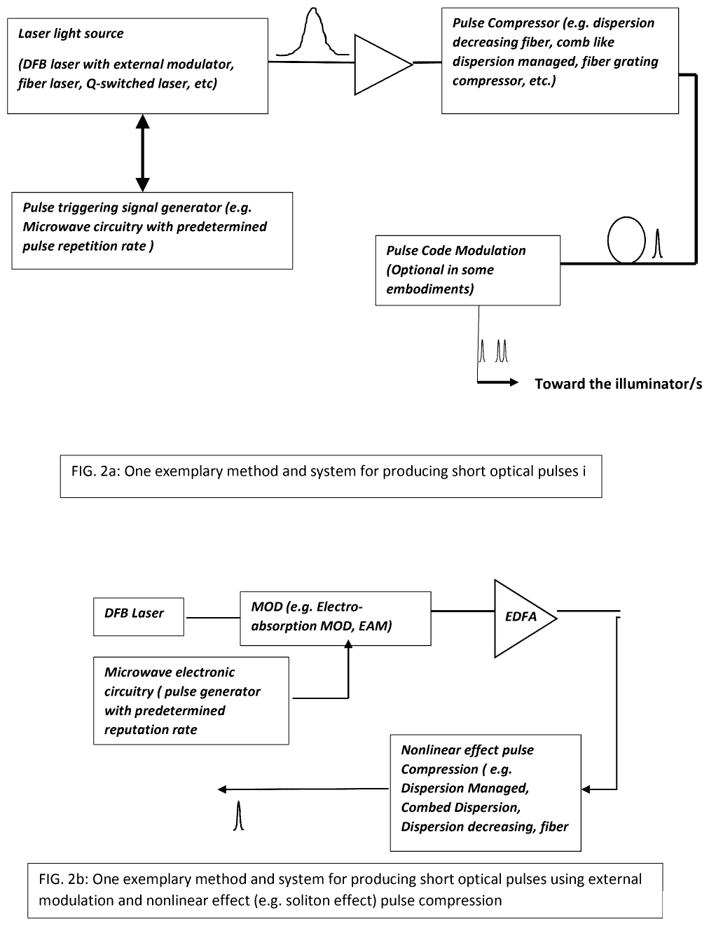

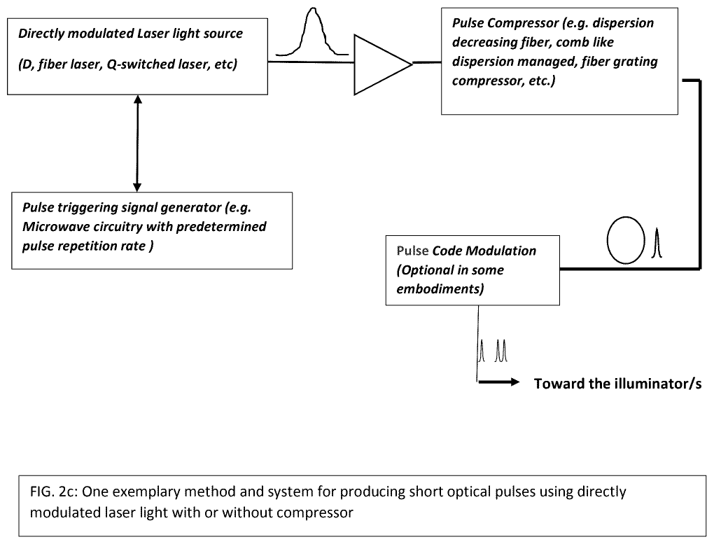

FIGS. 2a and 2b shows exemplary embodiments for generating short optical pulses. In FIG. 2a, for instance, there is shown a laser source whose output light is externally modulated (by for example, a Lithium Niobate (LiNbO3) external modular, an acousto-optic modulator, electro-absorption modulator (EAM), or a switchable attenuator or any other means impressing an electrical pulse on the output of a laser or an electromagnetic wave source). The optical pulses can be further compressed to achieve the desired pulse width and shape. For instance as depicted in the FIG. 2a, the compressor can be achieved by amplifying the pulses to a predetermined power level and pass them through dispersion decreasing piece of fiber, or through a length of dispersion managed fiber, or comb-like dispersion coefficient fiber, and/or by using a chirped fiber grating, and/or a diffraction grating etc.

As an another exemplary embodiment of producing short optical pulse in which there is a DFB laser (producing a CW laser light) and is externally modulated by an external modulator such as an electro-absorption modulate (EAM) derived by electronic signal, with the desired pulse shape and reputation rate, which is coming from an RF/microwave circuitry. FIG. 2b further shows that the output pulse, after the modulator impressed the electrical pulse onto the DFB laser light, is then amplified to a predetermined power level and further compressed by employing nonlinear effect pulse compression (e.g. self-phase modulation or soliton effect pulse compression) in a piece of dispersion managed, (e.g. dispersion decreasing) fiber optic or waveguide.

In FIG. 2c, shows another exemplary embodiment for generating optical short pulses in which directly modulated EM/light/laser sources are used in conjunction with optical amplifiers and pulse compressors to achieve desired short optical pulses and ideally in the form of optical soliton using nonlinear effect pulse compression (e.g. self-phase modulation or soliton effect pulse compression) in a piece of dispersion managed or dispersion decreasing fiber as depicted in eth FIG. 2c.

Other methods of generating short optical pulses can be used such as Mode-locked Q-switch laser diodes, fiber laser or in general any optical system capable of producing optical short pulse in the range of fractions of a picosecond (i.e. <10⁻¹² second) to few nanoseconds (i.e. >10⁻⁹ second) at the desired wavelength (such as 1550 nm).

Further before the illumination onto the environment, and according to some embodiments, the optical pulse can further be encoded into a burst of optical pulses to form an encoded pulse train packet, (which might form a unique code, or orthogonal to a very large number of possible pulse coded signals etc.). The pulse encoding, for example, can be done all optically by a number of optical couplers and one or more delay lines.

In some embodiments the burst of encoded pulses can be generated by the electronic systems and then impressed over optical signals in the form of direct or external optical modulations.

Encoding further can be done with diffraction grating, holograms, and any temporally or spatially encoding scheme deemed desirable for security, or non-interfering signaling with adjacent remote sensing systems such as the LiDARs that are used in vehicle for deriving assistance in full or semi-autonomous vehicles or robots etc.

### The Irradiatiing Beams (Illuminating Modules)

In this section we introduce electromagnetic or optical illumination modules which are going to be used to illuminate the surrounding in order to gain as much information and knowledge about the surroundings by a LiDAR system that uses one or more of the optical illuminating modules according to some embodiments of the present invention/s. According to several embodiments of present inventions, optical illuminating modules are provided that comprise one or more radiating and/or irradiating apertures to be used in one or more remote sensing embodiments of present invention.

Radiating or irradiating apertures are such structures to be used for illuminating a region of space by emitting or radiating or irradiating beams of light.

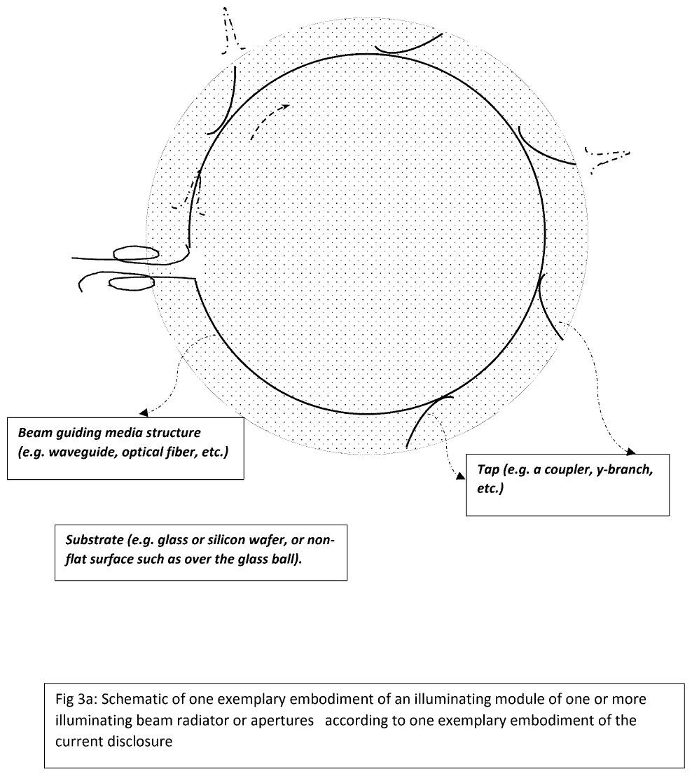

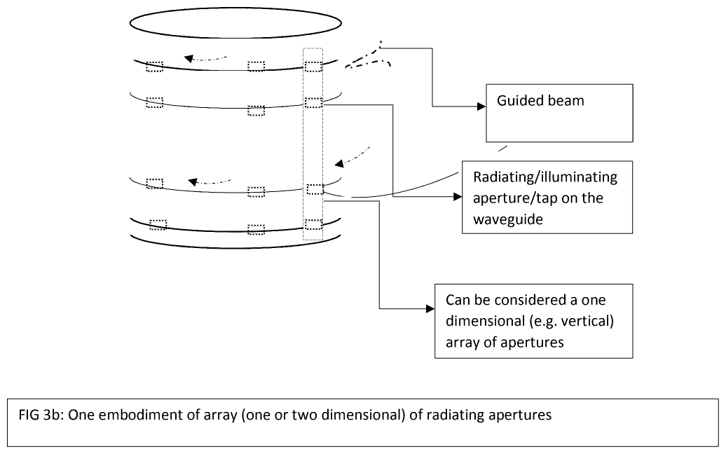

Referring to FIG. 3a now, FIG. 3a show a schematic of one exemplary embodiment of one or more illuminating beam radiator or apertures according to one exemplary embodiment of the current disclosure.

In this embodiment a beam guiding medium such as an optical waveguide or an optical fiber is fed with an optical signal which is, in one preferred embodiment, an optical short pulse, and wherein there are one or more optical taps in the form of optical directional couplers, γ-branches or partially reflecting mirrors (either integrated or discrete micro-optic module) and wherein the one end of the taps, (e.g. one of the branches or one port of a coupler) is exposed to an environment outside of the guiding media so as to radiate/irradiate a fraction of the guided optical beam into pre-specified direction of the environment outside of guiding media.

Accordingly in FIG. 3a: there is shown an embodiment of array of radiating apertures. These taps or apertures can be embed over a disc of substrate or be manufactured in the forms of various types of waveguide shape or structure with various fabrication technologies. For example the irradiating apertures arrays along the waveguide can be made by using ion exchanged waveguide fabrication process over a glass substrate or integrated with semiconductor fabrication process with ridge or other types of waveguide with silicon (e.g., silicon on insulator, SOI) as guiding medium, or by imbedding standard optical fiber in a substrate (e.g. silicon wafer or glass) over any desirable substrate. The whole guiding medium can be coiled around a supporting structure such as a glass tube or be implemented/fabricated over a disc and be concatenated by connecting the output of one disc to the input of the next disc if two dimensional aperture arrays are going to be built as shown, for example, in FIG. 3b.

However, the cross section of the coil or shape of the disc, can be any shape in principal but in one of preferred embodiments could be a cylinder or sphere, according to one exemplary embodiment of the present invention.

Moreover optical gain medium or optical amplification can be inserted between apertures or between the discs with irradiating apertures of FIG. 3a. Several configuration can be envisioned for amplification of the optical signal/s as they propagate, including, but not limited to, having the guiding medium doped with a materials, such as Erbium, Ytterbium, that possessing optical gain, or semiconductor materials (such as silicon-based or InP based or III-V materials) or polymer based active waveguides etc.

Furthermore, one can also integrate the photo sensing system on chip (e.g., by monolithic integration of electronic and optical components) next to the apertures as depicted, for example, in FIG. 4b.

Referring to FIG. 4a now, there is shown one embodiment of using optical waveguide with one or more light emitting/radiating/irradiating apertures placed, for example, in a vertical direction over a supporting configuration. Also shown in FIG. 4a there is an optical detection system comprising one or more photosensitive devices such as single photon avalanche diodes (SPAD), avalanche photodiodes etc. The detection system may further comprise the associated electronics to detect, decide, and convert the received optical signals into readable data with a desired format for further processing by one or more data processing units and/or one more data processing algorithms.

It is worth mentioning that the optical detector system of FIG. 4a, need not be attached to the aperture array. In general the detection system of FIG. 4a can be positioned at a desired location and in some embodiment a different location than the vertically aligned apertures of FIG. 4a.

In FIG. 4b there is shown an array of one or more emitting/radiating/irradiating waveguide apertures configured vertically over a supporting substrate (e.g., a glass tube or rode or a piece of any material desire-able) in which one or more light detector is also place adjacent (in any direction desired relative to the aperture, i.e., left and/or right and/or up and/or down) to one or more of the apertures.

FIG. 4c, further comprises one or more delay line to one or more of the emitting/radiating apertures. In some embodiment these delay lines are to provide desired delay between flight times of the pulses that are going to be irradiated from one aperture to the next aperture. In this way a predefined and exact timing for radiating/irradiating pulses are provided so that, when the returned signal/s are detected by the detector, there will be a known delay between the irradiated pulses so as to be used to even more accurately estimate a radial distance of an object in, for instance, a LiDAR system that uses such vertically aligned radiating/irradiating apertures,

Again, it is worth mentioning that in all of these embodiments the one or more detection device/system need not be collocated with the radiation/irradiating aperture/s and can be placed in different location that the radiating/irradiating aperture array/s.

In FIG. 4d further is shown radiating/irradiating apertures wherein the optical detectors further comprising collecting and/or collimating optics to direct the incoming signals on to the detectors more efficiently.

In FIGS. 4e1 and 4e2, shows exemplary embodiment of radiating/irradiating apertures that are places over a curved surface or stripe so as to each radiating/irradiating aperture send a beam in different angle and direction and illuminate a designated area of space (e.g. a very narrow field of view, i.e. a directive radiation/irradiation).

In FIG. 4e2. the apertures are aligned vertically and an optical apparatuses (such as a slightly curved lens) place over the irradiating apertures to deflect and distribute the illuminating beams into predefined areas of surrounding space (i.e., the azimuth and radial the angels).

Accordingly, these exemplary embodiments, demonstrate that with a single source or a guided beam (whether continues in time, i.e. CW beam, or temporal pulse/s, i.e. optical pulse/s) one can produce a plurality of high quality directive beams. When the guided beam temporal envelope is in the form of temporal pulse shape (e.g. having a limited time width) then the irradiating beam are also temporal wherein the time of the irradiating pulses (i.e. the time of flight of the irradiated pulses) can be precisely scheduled. In some of the preferred embodiments the guided beam temporal envelope is in fact a short pulse with very narrow time-width which can be produced by many desirable technologies as mentioned in the last section.

Referring to FIG. 5a now, there is shown another embodiment of an array of radiating/irradiating apertures comprising optical guiding medium which are coiled over an arbitrary shaped supporting rod or pole (e.g. a glass tube). The guiding medium is an optical waveguide or an imbedded optical fiber over the surface the supporting pole or cylinder.

FIG. 5b, on the other hand depicts a two dimensional array of irradiating apertures over a surface which might be a flat surface or a curved surface (such as over a glass tube) or any other suitable supporting to forma two dimensional array of irradiating apertures.

In FIG. 5c, on the other hand depicts another embodiment of two dimensional apertures distributed over two dimensionally curved supporting surface in which the radiated beams of each aperture radiate beam at different direction in to the space (i.e. different azimuth and different radial angle of propagation of beam).

In all the embodiments, apparently, the apertures are distributed over the surface to illuminate a desired field of views. For instance the apertures are distributed in such a way to cover 30° (i.e. π/6) in radial direction and 120° (i.e., π/6 radians) or 360° (i.e. 2π) in azimuth field of view.

In all these configuration above (FIGS. 4a-5d) delay lines can be inserted at desired place. For instance in the FIG. 5a or FIG. 5b, a length of guiding medium (e.g. optical fiber) can be added/inserted between adjacent apertures at the desired places (for instance after each round of coiling one can add more guiding medium to cause a desired delay between the time of irradiation of the pulses between adjacent apertures.

Again, it is worth mentioning that one of the, among other advantages of the present disclosure of remote sensing systems and LiDAR system in particular, is that the timing of flight of optical pulses or beams relative to each can be precisely controlled (from propagation time of an optical pulse/beam of one aperture to the next or another) which is extremely important in the reducing the timing jitters at the time of detection and eliminates one of the major contributor of the error in accuracy and resolution of LiDAR data. The current LiDAR systems that employ one or more light sources need to know exactly the delayed time between the flying times of the different pulses of an optical source by sensing the time of flight of each pulse from one or more light sources which make eth electronics even more complicated. In the current systems with a plurality of emitting light sources the triggering signals to optical sources need to be perfectly scheduled and timed. However in practice, controlling the timing signals electronically and also the timing of the operation of the light sources are extremely difficult and random in nature leading to inherent uncertainty and timing jitter.

Referring to FIG. 5e.a now, it shows another exemplary embodiment in which the irradiation is continues, i.e. which we might call continues radiation/irradiation mode of operation. In FIG. 5e.a there is shown schematically an embodiment of continues irradiating guiding medium which continuously irradiates away the propagating/beam pulse and illuminates the surroundings as the optical signal is propagating in that guiding medium. FIG. 5e.b shown an exemplary cross-section of such guiding medium (e.g. an optical fiber with exposed part of cladding) so that some of the plane wave components of the propagating beam are entered into the outer space (e.g. free space, air).

It is worth noticing and mentioning that FIG. 5e.a is indeed a special case of FIG. 5c or 5d wherein the adjacent aperture distance or delay time has approached zero (i.e. the δt_{da}→0). Accordingly all the future analysis and methods of recognition and detection and systems for irradiating apertures, which are going be followed in the next sections of present application and disclosure, can be applied to the continues radiation/irradiation mode of operation as well.

In the incorporated reference paper entitled “Extinction Ratios and scattering losses of Optical intersecting-waveguide switches with Curved Electrodes”, IEEE Journal of Lightwave Technology, 1994, page 1475-1481., by the same inventor, it was shown how a guiding beam can be decomposed to its plane wave components with different wave numbers each of which propagate at an angle in respect with the propagation axis. Accordingly some of the plane waves or rays of light can be partially be transmitted into outer space with exact temporal (time-dependency) of the propagating pulse inside the leaky waveguide (i.e. the leaky guiding medium).

As seen in FIG. 5e.b, and in another word, part of evanescent field of the guided beam is extended into outer regions or outside of the guiding medium structure.

For example, a piece of fiber can be coiled and/or embedded into a glass substrate and then the outer surface can be polished sufficiently to have some section of the cladding being exposed to the outside. Further an optical waveguide or an optical fiber can be designed with the right geometry and refractive index parameters and profiles so as to have a guiding medium in which the guided beam is not fully confined within the guiding area and the guided beam is irradiating into the outer area of waveguide as it propagates. The leakage ratio and radiation power from such leaky guided beam can be calculated, for example, by numerical simulation of beam propagating in such guiding structure. Moreover the optical waveguide can be made to compensate for the radiation of power into the outside either continually along the propagation path (e.g., make the optical fiber core and/or the cladding active with doped rare earth metals such as erbium) or periodically amplify the weakened propagating beam at certain propagation distances.

In this way as the short optical pulse is propagating through the waveguide, or the optical fiber with exposed cladding, it will illuminate the surrounding environment in an orderly and predictable timing and direction continuously so that the steering of light is done without the need of motorized or mechanical or solid-state micro-structure (e.g. MEMS), or rotating mirrors or polygons etc.

FIG. 5e.c and 5e.d in yet another exemplary embodiment of continually or periodically illuminating the surroundings without a need for two dimensional scanning or steering whether mechanically involved or using depressive optics (e.g. a dispersion element which directs flights into different directions based on their wavelength) or phased array and the likes.

Depicted in FIG. 5e.c and FIG. 5e.d shown an embodiment of two coupled guiding medium with pre-determined coupling coefficient wherein the beam/pulse is mainly guided through the core_1 and is coupled to guiding core_2.

FIG. 5e.d shown an exemplary cross section of such coupled guiding media in which there two cores in which some part of the cladding of the core_2 is exposed into outer region out of confined guiding medium. For example, or In other words, the cladding on one side of the core_2 is exposed to free space.

Referring to FIGS. 5e.c and 5e.d and yet according to another exemplary embodiment of this invention and without any restriction intended, the two guiding medium should be made asymmetric (e.g. with different core radius or different refractive indices etc.) to have a weak coupling between the guided modes of the core_1 and the core_2 so as to have a fractional energy transferred from the propagating pulse in eth core_1 to the core_2 from where again some of its coupled pulse's energy irradiates away into the outer space to illuminates the surrounding.

Furthermore, in this configuration (FIG. 5e.c. 5e.d) the irradiating intensity of light will be periodical wherein at certain locations along the propagation length of the guiding medium the irradiating intensity is minimized and in some other locations the irradiating intensity is maximum. Considering that the irradiation location is indeed can be translated into the direction the propagation of irradiated light/signal/pulse/beam into different region of the surrounding environments (e.g. in embodiments shown in FIG. 5a through FIG. 5e.a).

Again generally with careful design (i.e. the geometrical and/or physical characteristics parameters) and fabrication control over said dimensions (e.g. the core radius, the cladding thickness etc.) and physical characteristic parameters (e.g. refractive index, dispersion properties, choice of materials etc.) one can design and achieve to have a desired portion of the guided beam/pulse be irradiated into the space as it propagates through the guiding medium of FIGS. 5e.a/5e.b and 5e.c/5e.d.

Apparently, the continues illumination of the surrounding cause the propagating beam/pulse loses its energy as it propagates. Accordingly in some embedment's, according to the present invention/s, one or two of the cores can be made active to compensate for the irradiation energy loss as the beam/pulse is propagating through the one or two cores of the FIGS. 5e.a-5e.d. For instance, in one embalmment, the core_1 in FIG. 5e.c can be a glass-based core doped with Erbium and/or Ytterbium and having been pumped with pump laser source (e.g. by a DFB laser in the 980 nm wavelength region) wherein the illuminating beam/pulse is from a short optical pulse source at 1550 nm regions.

Many different guiding medium and structures such as optical fiber fabrication technologies, materials and structures, such as silica based fiber, polarization maintaining optical fibers, birefringent fibers, hollow fiber, photonic crystal fiber, micro-structure based fiber, band-gap optical fibers, polymeric based fiber, rare earth doped fibers, and or various waveguide fabrication technologies, such silicon on insulator (SIO) fabrication methods, III-V semiconductor manufacturing methods, ion-exchanged waveguide fabrication methods, sol-gel waveguide fabrication methods, can be used to realize, build, or manufacture or assemble such embodiments to achieve the desired functionalities within the scope an sprit of the concepts and exemplary embodiments of present inventions and disclosure.

To recap the exemplary structures and embodiments of FIG. 5e.a to 5.e.d can used to continuously sweep and illuminate a wide field of view (either in azimuthal or polar field of view) with temporal pulses and observe the reflected by one or more detection module/system/device or circuit and collect the remotely sensed data from the surroundings pass them for intelligent processing as will be disclosed and explained in the next section.

Yet in another embodiment according to the present invention, when we use sufficiently short optical pulse (e.g. sub-picosecond to few picoseconds full width at half maxim, FWHM) with sufficiently high peak power (to invoke self-phase modulation through nonlinearity of a guiding medium) and a guiding medium with appropriate characteristics (e.g. having notable Raman gain coefficient to cause self-frequency shift for short and high-power optical pulses) we can have an illuminating signal that its frequency/wavelength is changing as the signal/pulse is propagating along the guiding medium. Accordingly in this way (e.g. employing embodiments of FIG. 5e.a/5e.b, or 5.e.c/5.e.d) and regime we can illuminate and steering the surrounding with an optical signal with varying frequency with time and direction of illuminating so as to if one uses a coherent detection of the taped irradiated signal with a returned or reflected signals from distal objects in order to estimate the radial distance, direction and possible the radial and/or horizontal speed of the objects in general. For instance, we can have another coupling mechanism to tap the optical signal from the initial source (e.g. the master pulse generator or a CW laser source with external modulator) or even from outgoing or irradiating signal/pulse and direct it to the detector as a reference for frequency of the irradiating beam at certain direction and combined with the reflected signal/pulse frequency at a coherent detector.

In some other embayment one can employ the self-frequency shift mechanism in silica based fiber (or any other suitable beam guiding medium with a desired physical characteristic parameters such as Raman gain coefficient or the like) to have source

Referring to FIG. 15 in here now, which shown an embodiment of a yet another novel type of LiDAR using self-frequency shift frequency modulation, which is called “Continues Frequency Shifting Radiating Pulse (CFSRP)” in this disclosure. As seen in this exemplary, yet simplified, embodiment there is a continues wave laser source such as a DFB laser source (preferably with narrow linewidth) and an external modulator followed by a pulse compressor comprising an optical amplification and pulse compression module to produce short and powerful optical pulses and then send them through the illuminator which is for example can be comprising the illuminator embodiments of FIG. 5.e.a or more preferable FIG. 5e.c) wherein optical pulses experience self-frequency shift as they propagate, for instance, in core_1 of FIG. 5e.c/5.e.d, while also they irradiate a portion of their energy as they sweep/scan/steer the environment.

In this embodiment, since the frequency of the irradiating signal is an indicative of the direction of the irradiated beam then by coherent detection of a returned/reflected and measuring the frequency of the beat signal at the detector, one can uniquely identify the reflective object's location or coordinates. Moreover in this embodiment or mode of operation the irradiating frequency is also indicative of the time of flight of the irradiating signals which are known values (or can be calculated analytically) which make the processing and calculations and/or estimation of coordinates more reliable and straightforward.

While the timing of irradiation at each direction can be known very precisely the knowledge of the irradiating frequency will may have less certainty in this embodiment. In some embodiments for greater certainty, the irradiating frequency can also be dynamically estimated by measuring the entering/initial frequency of propagating beam and the peak power and/or the exiting frequency at the end of each frame scan (e.g. when the optical signal has reach the end of the coiled in FIG. 5e.a or 5e.b). Among the advantage of such methods of illumination, and signaling and detection of a LiDAR system of FIG. 15, is that the a distant/direction-dependent frequency modulated (e.g. the signal that experience frequency change without losing its integrity, e.g. soliton self-frequency shift) signal is sent out to the surrounding at a very fast when each point (or small region of space) is only exposed to a peculiar frequency or wavelength and the waiting time for receiving echo or reflections can be considerable (depends on the quality of the CW source laser) and therefore the such LiDAR's can be used in various range applications such as short range, ling ranges and ultra-long ranges.

It should be noted that even though the guided beam is temporal (i.e. time-dependent pulse) but the irradiated signal in this configuration is continues although it is sweeping the field of views very fast. Accordingly the there might not be enough time for the coherent detector to become able to detect the beating signals between the reflected signal and that of the reference signal since the reflected signal from a small area of the reflective object is in principal short lived (as short as the guided preparing pulse) but the hope is that the continues reflection from real object, which are usually large objects, make it possible for the coherent detector to measure the frequency of the reflected signal from eth object and hence its location.

If the coherent detection for this embodiment prove to be extremely challenging other ways of distinguishing the reflected wavelength (such as use of diffraction grating at the receiver to redirect the returned signal based on their wavelength into different direction in combination with an array of photosensitive devices) might be employed. Those skilled in eth art can envision other variations and methods of estimating the wavelength of the returned signal in order to, consequently, become able to estimate the coordinates of the distal reflective objects.

On the side note, again since the scanning, or steering mechanism does not deepened on critical parameters such as phase or frequency, or wavelength or mechanical moving part (either Nano-size or micro-size or bulk or motorized) the resulting illuminating and signaling scheme will much more robust than those remote sensing technologies that are based on careful control of phase, frequency, or wavelength for detection and/or steering/scanning or using moving parts for scanning fields of view.

According to one embodiment of this disclosure the guiding medium can be imbedded in the front or rear vehicle transparent window so as to cover a narrower but a desired field of view in front or rear of a car or a vehicle without having to use other means of illumination support base or having a noticeable device on top or a part of car or vehicle.

### An Exemplary Operation of the Sensing System

Referring to FIG. 6a now, there is shown a schematic depicting a conceptual operation of a remote sensing scenario according to one exemplary embodiment of the present disclosure. Shown in FIG. 6a is the propagation of different beams (which might comprises of packets of optical pulses, or burst of encoded pulses) into a direction in which the beams are incident onto an object, at different spots of the object, and are reflected back towards an optical detector at the sensing system (e.g. the LiDAR system, or a detector at a designated location)

FIG. 6a shows that different areas/spots of the distal object are illuminated by different beams (from different irritating apertures of FIGS. 4a-4e1-2, and/or FIGS. 5a-5d). For continually irradiating embodiments, such as the one depicted in FIG. 5e.a, the same concept of operation still applies.

As shown a packet of burst of pulses (which might be coded in time, amplitude, pulse width, code width, or phase) are sent from the irradiating apertures at slightly different timing wherein the incident beams are reflected back to a detection system that might comprises one or more photodetectors.

It is apparent to the skilled in the art that FIG. 6a is one exemplary embodiment to depict conceptually the operation of a remote sensing system (e.g. a LiDAR system) and many modifications can be envisioned such as placing the apertures at different places than the ones depicted in FIG. 6q, and or the pulse packet burst have different shapes or timing arrangements or pulse durations varying and the like. For instance the aperture can be configured to be located in an angled line relative to the vertical access of the apertures' supporting substrate.

### Irradiating Apertures

Here at this point of disclosure, we try to answer the logical question of what is the irradiating apertures and how are they going to operate and be constructed.

FIGS. 7a-7i show few exemplary embodiments to make an irradiating aperture from a beam guiding structure such as optical waveguides and/or optical fibers with various materials.

In one preferred embodiment we can use a length of single mode optical fiber (e.g. a single mode silica fiber from corning) as the guiding medium for an optical beam. The beam propagating in a single mode fiber (SMF) have very nice and collimated spatial profile with ad almost narrow Gaussian spectrum of wave numbers (the Fourier transform of the filed profile in the lateral direction).

However other types of guiding medium and structures can be used for this purpose (e.g. creating a radiating aperture). For instance, ridge (composed of glass or semiconductor or any material deemed suitable and desirable) waveguides, graded index waveguide, ion exchanged glass waveguide, polymer and plastic fiber or waveguide, sol-gel waveguide, or microstructure (e.g. photonic crystal, hollow fiber etc.) can be used without restricting the scope of the present invention.

In the preferred embodiment, we are using a single mode optical fiber (with desired dispersion profile around the desired operating wavelength such as 1550 nm) and secure that over a substrate. For instance an optical fiber can be imbedded into or thatched onto a glass tube in the form of coil.

Consequently, and beam reflecting disturbance (e.g., in the shape of a V groove or a recess) is carved out the guiding medium (e.g. the optical fiber) to cause some or predetermined portion of the guided beam to be reflected and branched out into surrounding medium as shown in FIG. 7a. For instance a recess can be created carefully on the fiber (preferably secured over the substrate) by way of laser cutting, or chemical etching, or plasma etching or any other methods to create such reflective recess in the propagation path pf the guided beam s as to cause some of the energy of the guided beam to radiates away to the surrounding environment (e.g. into the air or the media having refractive index of n₀) α₁ and α₂ is adjusted in a way to have a predefined portion of the guided beam is reflected applying Snell's law (e.g. refraction and reflection of optical rays from materials interfaces), or by way of numerical simulation of beam propagation (e.g. the electromagnetic wave equation with spatial waveform function).

The principal operation is self-explanatory which is basically the incident guided beam enters a new medium almost without a loss of energy and enter into the guided medium again at a second interface wherein the parameters, in FIG. 7a for instance, are selected in such a way to have a predefined portion of propagating beam being reflected and enters into another medium (e.g., a free space or air etc.).

FIG. 7b, shows, for clarity and generality yet, another embodiment similar in operation o the FIG. 7a, in which the groove area is filled with a material with refractive index of n₃ and in which the guided beam enters at perpendicular angle at the first interface and the α₂ angle again is selected based on physical parameters (e.g., the refractive indices of all regions of FIG. 7b and the/or dimensions of the waveguide and the recess/groove area) in such a way to, again, having a predetermined portion of the energy of the guided beam enters or radiate way into the surrounding region with refractive index no.

FIG. 7c, on the other hand shows another way of causing to tap some energy of the guided beam and to cause to radiate away into the desired media by exposing the cladding area of the waveguide (e.g. by carving away a portion of the cladding of the single mode fiber so that the evanescent field of the propagating beam can radiate away and escape into a desired media (e.g. the free space or air). The parameters of the FIG. 7c structure then again can be calculated by numerically solving the propagation of the guide beam in such structure to given the desired output and to find the parameter d (the distance that waveguide core has to be exposed into another material with refractive index of ne to satisfy the radiated beam energy and to minimize the possible losses of energy of both radiated beam and the transmitted beam as shown in FIG. 7c.

In FIG. 7d, shows another exemplary embodiment of radiating aperture over a beam guiding structure (e.g. an optical waveguide) in which the exposed guiding core is field with more than one material with different refractive indices to have a desired form of radiated way beam shape and angle and energy. Again the parameters of the FIG. 7d configuration can be obtained by numerical simulation and numerical solving the propagation respective wave equation representing the propagation of a guided beam entering such an structure and obtain the parameter which yield the desired designed objectives (e.g the radiated beam shape, and the radiated away beam energy, the optical losses etc.). Those skilled in the art can intuitively find the parameters by way of rough calculations.

Referring to FIG. 7e. shows a more general case making a radiating aperture over an optical beam guiding medium/media with using the concept of radiating away by letting some spatial section of the guided beam been exposed to another media with the desired shape and index. Again the parameters of the design can be obtained by numerical simulation and solving the wave equation repressive of the guided beam in that structure or media.

Refereeing to FIG. 7f, there shown another exemplary way to cause radiation of a portion of guided beam being radiated away into a desired medium (e.g. air). As indicated in FIG. 7f, the waveguide is tapered down in one or both side of the waveguide so as to widen the cross section of the guiding beam and cause that some of the guided beam being radiated into, for instance, free space.

FIG. 7g shows, yet another exemplary mechanism, to tap some of the guided beam energy away into the desired medium such as eth surrounding air, by creating an oblique grating structure along the propagation direction of the guided beam. For instance, using ultraviolet light sensitive optical waveguide and a phase-mask with the desired pattern one write the grating over the waveguide (e.g. over the optical fiber) at oblique angle to couple some propagating guided beam into a reflected beam at a desired angel as shown in the FIG. 7g.

And finally referring to FIG. 7h now, there is shown another embodiment to tap away a predetermined portion of the energy of a guided beam and redirect in the desired media and direction in which the guided beam meeting a disturbance in the form of an oblique groove/recess or canal (which might be filled with a material) with predetermined refractive index and thickens. Since usually for this application (e.g. the illuminating module for a LiDAR system according to exemplary embodiment of the present invention) we only need to tap away a small portion of the energy of guided beam therefore the disturbance in the propagation of the guided beam should be negligible. In other words the refractive index of canal or the oblique groove should be very close to that of the refractive index of the guiding media. On the other hand when, according to one preferred embodiment, the guiding media is a single mode optical fiber the refractive index of n₁ and n₂ in FIG. 7h are already very close (to yield a single mode operation) and therefore the refractive index of n₃ in FIG. 7h should be only slightly different (usually slightly larger than the effective refractive index of the guiding media) so as to only a small portion of the beam energy is reflected at the second boundary. With the help of controlling n₃ and α₁ in FIG. 7h one can achieve at the desired parameters to have the desired radiated away beam with the predetermine portion of the energy of the incident guided beam.

One can, for the sake of clarification and heuristics, select a single mode optical fiber with core refractive index, i.e., n₁, of 1.452 and the cladding refractive index, i.e., n₂, of 1.447 and having n₃ about 1.47 and oblique angle α₁ of 45° with the canal width of several micron to several tens of micron. It should be emphasized that these are just heuristically selected parameters and a more precise design parameters has to be done by way of careful calculations or simulation. The calculation and numerical simulation should be and can be done by an ordinary skilled in the art of electromagnetic system and device and/or photonics systems and device, and/or optical system and devices.

In such exemplary heuristically designed structure, the guided beam enters the oblique groove (i.e. the canal) almost without a loss and negligible deflection from its axis of propagation and then when it meets the second boundary interface the beam is reflected at angle 90° angle with respect to the propagating beam axis. The amplitude, i.e., the energy or the intensity, of the reflected beam therefore is determined by the reflection coefficient of light at such angle (e.g., 45°) and at the boundary condition and for the given or preferred polarization.

FIG. 7i, on the other hand, shows another example waveguide with irradiating aperture same as FIG. 7h, in which the refractive index of the canal or the oblique groove is slightly less than the effective index of the guided media for the guided beam. For example depicted in the FIG. 7i, mentioned that for instance the refractive index of the canal, i.e. the n₃ is less than the refractive index of both core and the cladding of the optical waveguide, e.g. the single mode optical fiber in eth preferred embodiment. There are several ways to make such structures. For instance, one may use dicing saw with the appropriate thinness to cut an optical fiber, (which for instance, is emended on a substrate) at an angle. After dicing at an angle and creating the oblique recess/groove/canal one may further fill the gap with a material with a refractive index to achieve the desired results in terms of irradiating beam angle and power and shape.

Referring to FIG. 7j now, it shows another exemplary embodiment of a beam guiding medium with the irradiating aperture in which the reflective interface is curved in general and in one exemplary embodiment the curve is in the form of a logarithmic spiral. In this case it is shown (see, for instance, the paper entitled “Low loss optical waveguide-bend configuration with curved corner reflectors” By Hamid Hatami-Hanza et al., Electronics Letters, December 1992 which is incorporated, herein, as reference.) that the reflection loss or transmission loss is minimized since all the constituent plane waves (having different wavenumber and angel propagation) can be ranged to incident the curved reflector with the same angel and as the result experience the same reflection coefficients.

Furthermore, in some and/or all the embodiments, further optic modules (such as micro lenses, filters or other ways to designs and form the outgoing beam profile and divergence angel etc.) can be used and designed and managed to achieve highly collimated outgoing beams

Again, it is mentioned that, according to one embodiment of this disclosure the guiding medium can be imbedded in the front or rear vehicle transparent window so as to cover a narrower but a desired field of view in front or rear of a car or a vehicle without having to use other means of illumination support base or having a noticeable device on top or a part of car or vehicle.

### Guided Beam Amplification (Outgoing Signal Amplification)

When each aperture radiates away some of the energy of the guided beam (or the temporal optical pulses), there comes a need to amplify the pulse or the guided beam as it propagates along the guiding medium and radiate away some energy into surrounding environment through irradiating apertures.

One way to compensate for the radiated portions of the guided beam's energy and some inevitable losses at each aperture (e.g. possible multiple reflection at the aperture boundary, the beam reentrance into guided medium insertion loss, scatting loss, diffraction loss, etc.) is to amplify the beam as it propagate along the gain medium (e.g. pumped optical fibers as both amplification and guiding medium. However the high power of the pump laser needed may not be suitable since at the apertures some of these pump energy will be lost and might not be safe.

Another way is to insert amplification sections between apertures or parochially amplify the weakened beam as predetermined locations.

In FIGS. 8a and 8b, shows one exemplary embodiment in which the guided beam can be amplified and be restore its energy by using a two coupled guided medium (e.g. optical waveguide couplers, or dual core optical fiber, etc.) in which one of the guiding medium (e.g. one core of the twin-core fiber) is active and is pumped by a laser pump source (at 980 nm for example in eth case of Er-doped optical fiber amplifies or the so called EDFA) with very negligible coupling to the other core at the pump wavelength and a desired coupling coefficient at the pulse signal wavelength (e.g. 1550 nm) to the other core.

In some embodiments both core can be active (e.g. doped fiber cores) but only one core is lit with pump laser and there is negligible coupling between the core at the pump wavelength but some considerable energy coupling with the non-pumped core.

FIGS. 8a and 8b also show that, for instance in these exemplary embodiments for beam amplification or other reasons, the aperture is operating or is made only for one of the core (e.g. the non-active core meets the irradiating apertures by, for example, one or more methods shown in FIG. 7a-7j)

There are more ways to compensate for radiated portion of the beam (i.e. the guided short temporal pulse or pulse train burst or pulse train packet etc.) by using discrete or by integrating semiconductor optical amplifier section after one or more apertures or using heavily doped waveguides to have compact amplification and so on. The selection of the method/s for radiated beam compunction would depended on the tools and the technology/ies which is at the designer's disposal as well as other design constraints such as cost, physical dimension, weight etc. and in general the constraints of the desired irradiating apertures array/s in general and a corresponding LiDAR system in particular.

Moreover, the propagation of the short optical pulse/beam in the guiding medium with discrete irradiation (e.g. one or more irradiating apertures as introduced above) or continues illumination (e.g. FIG. 5e-a to FIG. 5ed) can be unidirectional wherein the short optical pulse can be entered from each end of the illumination optical module (e.g. all the Figs from FIG. 3a to FIG. 5e.c) or be bidirectional or counter propagated through both end. In some embodiments (Fig not shown but can be easily imagined) the optical pulse cane enter from one end (i.e., a first guided propagation direction) and after some delay the optical pulse will enter from the other end (e.g. a second guided propagation direction) of the illumination module to propagate and or scan the field of view in a counter direction to the first direction. A careful timing of entering pulse and delay lines in these counter propagating or counter scanting embodiments can facilitate the detection of surrounding objects to be estimated more precisely by providing additional data points in the detection section.

### The Sensing and Detection

As is the case for all of the shown or not shown embodiments of a LiDAR system to work and for all embodiments of illumination module and it is shown explicitly in several configuration in FIGS. 3a-3c, as well as 4a-5c-6a, for the sensing system to work it need a detection mechanism or device or module or system that will sense (or detect) the reflected signals (e.g. reflected pulses) from surrounding objects. The role of the detection system is to sense an detect the reflected signals, process them at analog level and most often convert the detected returned signals into digital format and reads them and process the data to deliver the information and knowledge of the surrounding into desired format (e.g. point cloud data).

Accordingly one or more light detector is used. For better efficiency some optics is going to be need to collect and direct as much as the desired reflected signal to the optical detector to increase the signal to noise ratio of the resulting electrical signal as much as possible.

According to one of the embodiment of the present disclosure we intend to use one detection system (as opposed to having a plurality of detectors as It is customer in laser array LiDRAs).

In order to use as few as possible detection system the present invention uses an optics that can collect the reflected light for the entire desired field of view (e.g. 120°, i.e. 2π/3 radians, or 360°, i.e. 2π radians, in azimuths and/or 15-60° in polar direction, just as an example)

Referring to FIG. 9a now, it depicts one embodiment of an optical module/apparatus/system, according to the present disclosure, that collects and redirect the light towards one or more detectors. As seen the optical module/apparatus/system comprises an outer shell (which is shown as a concaved curved outer shell but not necessary to be curve red) which first collimate the incoming rays of light (e.g. the reflected light from the objects surrounding the emitting or irradiating system/s of previous section of this disclosure) towards an internal ray reflector (shown as internal ray reflector in the form of cone shape mirror for instance or part (less than 360° azimuth) of a cone shape) from where the rays are further directed towards a lens before hitting on one or more photosensitive devices such as an photodiode or an APD or SiPM and the like).

It should be emphasized that the FIG. 9a shown one embodiment to collect the light in a wide range of direction and direct it to a one or more photosensitive device. Those expert in the art can use different configurations to achieve the same or modify the exemplary embodiment (for instance not using the lens over the photosensitive/detector device or use several other optical elements to further collect and direct as much light as possible from the wide angle of view)

Referring to FIG. 9b, now, shows another example embodiment of an optical module for collecting and directing reflected lights into one or more photosensitive device according to one exemplary embodiment of present invention.

In FIG. 9b, the ray reflector is curved so as to, for instance, direct the collected and collimated light by the outer collector in a parallel to each other (or any other angle) direction.

However collecting, light from all angles may increase the ambient or background noise and therefore degrade the signal to noise ratio, however since our pulses are distinct in time (they fly at different scheduled time) the background noise is almost constant and the reflected detected reflected signal can be distinguished in principal. For instance by accumulating the detected signals over time we can see distinguishable returned signal which will correspond to real objects in a distal positions because signals are correlated while the noise are not. As will be seen in eth section IX.I with the help of participation matrix concept and approached such operations and calculations (such as accumulating a detected signal as function of time over certain periods) can be done or calculated as at ease.

However, as will be shown, in FIG. 9c, the detector system can itself be comprises of several photosensitive devices (e.g. several APD mounted fabricated on a common board or substrate) in which each of the photosensitive devices will sense on the collected light from a narrower angle view.

Therefore according to some embodiments of the present invention, the detector module of FIG. 9a or FIG. 9b can have one single photo-detective/sensitive device (e.g. one SPM devise or SiPM or APD) or having an array of photo-sensitive detector as shown, for example, in FIG. 9c, and yet having an omnidirectional detection system as a whole.

Referring to FIG. 9c again, it was mentioned the detector system can itself be comprises of several photo-sensitive devices (e.g., several APD mounted fabricated on a common board or substrate) in which each of the photosensitive devices will sense on the collected light from a narrower angle view. FIG. 9c shows one embodiment in which photosensitive devices are fabricated (e.g. monolithically) or mounted (e.eg. SMD type device and installation) over a substrate and in eth exemplary embodiments shown in FIG. 9c are arranged around an arc (or around a whole circle depend of the field of view) so as to when is used with optical modules of FIGS. 9a, and 9b then with one single collector we can have directive detection. In other words with the optical arrangement of, for example, FIGS. 9s, and 9b in which light can be collected and directed toward a detection system from all angles yet we can sense the direction of the incoming (e.g. a returned signal from a reflective distal object) by observing which photosensitive device of FIG. 9c has detect the signal. As will be explained in eth next section (e.g. the intelligent comprehension) the photosensitive devices of the FIG. 9c are indeed can be regarded or be assigned with a state component with particular index/s whose values can be regarded as state component of order k wherein the value could be either binary (either detected a signal or not) or digitized or continues value depends on the processing facilities that is intend to be provided for data processing in eth whole detection and comprehension unit/module. We will explain how to use the state of each photo-sensitive device of 9c in the next section or it can be exercised and implemented by the teachings of the incorporated reference the U.S. patent application Ser. No. 17/574,263 entitled “Methods and systems for state navigation” filed on Jan. 12, 2022.

Referring to FIG. 9d now, it depicts one exemplary embodiment for sensing and reading (i.e. we may call it a sensing/detecting/digitizing unit) the detected a returned optical signal. As seen the incoming signal (e.g. the returned signal from the LiDAR illumination as a function of time) will be collected and directed, by the optical collector module as shown in FIG. 9d, toward the photo-sensitive device wherein eth optical energy (light intensity) is converted to an electrical current/voltage signal as the detected electrical signal. The signal corresponding to eth sensed optical signal, or the detected electrical signal is further amplified by a low noise electrical amplifier where afterwards the amplified signal is further converted to digital signal with a predefined clock speed from where the digitally converted detected signal will pass towards data processing units and/or intelligent comprehension module/unit. Shown in FIG. 9d, as one optional and exemplary embodiment of the present invention, is the case that digitized detected signal is also delayed by pre-determined delaying time and then pass forward to the processing unit/s. This exemplary detection system is to demonstrate and disclose some embodiments in which data respective of the detected signals by one or more photo-sensitive devices are read independently and certain clock speed and one want to serialize the data from various detection devise and/or interleave them. One such application case is using a single detector device for the diverse LiDAR system of FIG. 10b.

Furthermore, in an another exemplary detection module embodiment, the sensing/detection/digitizing unit of FIG. 9c can be monolithically or discretely integrated into same board or substrate either by silicon photonic fabrication process or III-V semiconductor material and fabrication methods or any other fabrication systems and methods or discretely be integrated on an electronic board.

It is worth noticing that in practice, without intending to restricts any scope of the present disclosure, and for long range sensing or LiDAR system application at 1550 nm wavelength for example, the reflected back rays/signals are almost parallel (e.g., paraxial) and hit the collecting optics at the almost at the same angle.

Optical Illimination and/or Optical Pulse Signailing and Modes of Operations

### VII.I Signaling:

For signaling and time encapsulation we would have several parameters to choose for designing our remote sensing system (e.g. the LiDAR) according to one exemplary embodiment of the present invention:
δtₚ: which is the pulse width (short pulse in the order of, e.g., 1 ps to 10 ns)
δT_{c}: which is the pulse coded time width (e.g., tens of picoseconds to tens of nano-seconds)
δt_{da}: which is time delay between adjacent aperture (time that takes from one aperture to aperture to next aperture in the, e.g., in the polar direction for one-dimensional vertical array or between two adjacent aperture in the azimuths direction for a two dimensional aperture array (range of few pico-seconds).
δTₛₐ: One round scan time in one direction (e.g., azimuth range scan 120, 360 degrees),
δT_{ex_ar}: an extra delay time after one azimuth scan round (in the range of 0 to tens of micro-seconds)
δTₐᵣ: time delay between adjacent aperture in the vertical direction (in the range of nano-seconds)
ΔTₛᵥ: which is the time delay for the light to travel one frame (e.g. one whole scanning in both directions, or e.g., through one coil of optical fiber for instance from FIG. 5a, 5b, or 5c; and in the order of, e.g., tens of nano-seconds to several tens of micro-seconds)
δT_{ex_sv}: an extra delay time after one whole scan view (e.g. light travels the whole both directions FOVs) on both directions azimuth and polar/vertical scan round (in the range of 0 to tens of micro-seconds)
ΔT_{Tr}: it is a predetermined time interval for recording the time events (e.g. in one convenient time window could be the inverse of predetermined pulse reputation rate/frequency which is, for example, one frame rendering round) and could be in the range of tens of millisecond to few seconds)
ΔT_{RR}: it is a predetermined time interval for recording the time events and could be in the range of tens of millisecond onwards.

Referring to FIG. 10a, now, it shows an optical pulse illumination signaling according to one exemplary and general embodiment of the present disclosure.

Further we will discuss few exemplary mode of operations of some of the illuminating embodiments and/or the operation of the proposed LiDAR systems.

### VII.II Few Modes of Operations of Embiments

VII.II.I One Dimensial Array of Sources and/or Aperture Array

In this mode or embalmment we can have a single source of a short or ultra-short optical pulse by, for instance, directly or externally modulating a laser source (such as DFB laser) and compress the pulse to an ultrashort pulse by way of, for instances, chirped grating, diffraction grating, dispersion decreasing fiber, dispersion managed fiber, comb like dispersion fiber and the like to achieve high quality and high power short optical pulses. The pulse width could be in the range of 0.1 picosecond (i.e., 10⁻¹³ second or 0.1 ps for short) to few nanosecond (i.e., 10⁻⁹ seconds or ns for short).

Then the pulses may have been encoded at the RF/mm electronic level (e.g. radio frequency or microwave circuitry and/or high speed digital processor to produce the desired electronic pulse, pulse trains, pulse packet, etc.), before impressing their electrical signal on the laser source or an eternal modulator, or be encoded all optically after initial pulse being generated by, for instance, combinations of directional couplers and delay lines or optical splitting devices, (e.g. optical divider/braches, optical delay lines, and one or more combiners).

Without the loss of generality and for sake of simplicity of explanation let's assume, according to one embodiment of the present invention, the pulse code only contain one optical pulse (i.e. the pulse code burst in FIG. 10a has or is represented by one optical pulse).

Now the optical pulse start to travel through a length of optical medium. Again for the sake of explanation and clarity we assume the guiding medium to be an optical fiber and preferably a single mode optical fiber having a number of irradiating apertures in the path wherein said apertures are vertically aligned over the a substrate (e.g. a glass tube or any other suitable material structure) as shown, for instance in FIGS. 4a-4e.2 or FIG. 5a).

As shown conceptually in, for instance, FIG. 6a, the optical burst of pulse radiate from apertures one by one with a pre-specified delay in time and are reflected back from a distal object. The reflected signals then are collected and detected by one or more detector as shown in FIG. 6a.

The irradiating beams/or pulses are then start to propagate into the space at the specified times (that is determined by the optical path from one aperture to the next that is, usually, a constant length). The time delay between the vertically aligned apertures is denoted by δTₐᵣ in FIG. 10a.

Now referring to FIG. 10a, we can depicts the outgoing signals/pulses, temporal beams) in the time axis. However there is relation between the aperture location and the time of flight of the pluses as is clear from FIG. 10a. In this way we would in fact has illuminated one vertical lines in the sorrowing by short optical pulses one point after another with time delay between them at the pre-specified time delay which is determined by eh optical length between vertically adjacent aperture. The total time to send all scanning signals in vertical direction then is denoted by:

$$total vertical line scan = N \times δ {T}_{a r}$$

Wherein N being the number of apertures in the vertical direction.

In this mode of operating, and/or one dimensional aperture array, embodiment, then the optical receiver or detectors start to detect the reelected signals from the objects in the surrounding environment. Depends on the intended range of the LiDAR operation, we then wait for a pre-specified time (e.g. one or few microseconds) to collect, detect and perhaps digitize the returned signal and record them in a numerical data arrays to be processed and used later on.

To cover the desired field of views, in this mode of operations, the vertical array of irradiating apertures are rotated in horizontal or azimuths direction after a pre-specified time and the short optical pulses will be sent through the optical fiber and the vertical scanning line is repeated for an slightly different vertical line adjacent to the previous step locations and in this way the scanning is performed in both directions for the given or desired fields of views (e.g. the vertical and horizontal scanning range).

The accuracy and resolution of measurements in this mode of operation (vertically aligned apertures) should be sufficient precise. That is because in many applications (such as the remote sensing system being deployed in a vehicle for deriving assistance or full autonomous vehicles) the observed object do not have large and/or sudden changes in the shape specially in eth vertical direction (vertical in respect to the ground for instance). When one vertical line is illuminated by the vertically aligned apertures (e.g. by illuminating another vehicle in front of the car, or a tree or a human etc.) the detected signals, once is detected after sending out the first pulse from the first aperture, is expected to be smooth and almost continues. Given the time delay between the irradiated pulses from the vertically adjacent apertures, then the range resolution in meter or cm is expected to be excellent. Furthermore, for the same reason the possibility of multiple reflected pulse reaching at the same time on the detector is also minimum and therefore the signal to noise ratio (SNR) of the detected signals are expected to be high which give the detection system a clarity and enough certainty and accuracy about the size, range and other attributes of the objects being detected or recognized. This accuracy and confidence on the other hand further relaxes the requirements for complicated data processing to even more accurately decipher the surrounding environment (as we will see for other modes).

The drawback, however, might be that the one dimensional aperture array need to be rotated (perhaps by mechanical means such rotating motors or rotating mirrors, rotating hexagon, oscillating mirrors, MEMS, etc.) to cover the desired range or field of view of the remote sensing system as presented by the current disclosure (e.g., the LiDAR according to present invention).

### VII.II.II. Dirversified Operating Mode

a. In this mode similar to one dimensional aperture array we would have more than one vertical array located at predetermined relative azimuth angle to each other. Again for the sake of simplicity we consider the guiding medium to be single mode optical fibers coiled and secured on around a supporting substrate and each vertical line of apertures are placed at some angle, Ω in FIG. 10b, relative to each other.
b. In here, again for the sake of clarity and in one exemplary embodiment, we want in each azimuthal light travel through the guiding medium and illuminate two points in opposite side (i.e. Ω=180°) albeit with a pre-specified time delay (e.g. ½×δTₐᵣ) and vertically scan the objects in opposite sides of the sensing system (e.g., the LiDAR) wherein the reflected or echoed signals/pulses, are detected by two independent detectors. The corresponding detected signals or data is kept or recorded or registered in a temporary storage device/s (the detected analogue signal can be delayed or being digitized and be registered or recorded or kept in data storage devices).
c. In this exemplary embedment (180° azimuthal angle apart vertically aligned apertures) we can then uses a 360 digress scanning on the horizontal direction. In this way in each rotation we have scanned the object twice independently at slight different times. The signal from both receivers and detector can be used to increase the signal to ratio of a returned signal carrying the information about an object by shifting and adding the two signals. Since the detectors were independent of each other the really informative part of the detected signals adds up but the noise part of the detected signal do not adds up with same ration (ideally the signal amplitudes are added to each other linearly but square noises' amplitude will be added with the power of ½, i.e., the square root rate).
d. Furthermore, also there would be a possibility of estimating the speed of the objects by looking at the non-deterministic (note that part of the delay in the returned pulses of between two vertical is known by the design) delay in reflected signals from both detectors.
   . . .
      VII.II.IIi. Two Dimensioal Irradiating Aperture Arrays and/or Scanning Flash Mode of Operation
e. In this configuration, or mode of operation or an embodiment according to the present invention, we have place the irradiating apertures in both the azimuth and polar angle direction as shown in, for instance, FIGS. 5b, 5c, and 5d. FIG. 5e.a-5e.d also shows another two dimensional irradiation scanning flash mode of operation with continues irradiation or sweeping.
f. The illuminating signals (pulse or a bursts of pulses) irradiate from periodic apertures as they propagate through a guiding medium such as a single mode fiber or an optical waveguide.
g. FIG. 10c shows one general illustration of optical signaling according to one exemplary of the embodiment of the present invention. FIG. 10c, in conjunction with FIG. 5b, FIG. 5c and FIG. 5d will complement each other in explaining the operational principal of the embodiment (i.e. the two dimensional illuminating aperture arrays). This mode is rather general and the signaling, shown in FIG. 10c, can be used to explain all previously explained modes of operation.
h. In this exemplary mode of operation short optical pulse packets (e.g. a single pulse or a burst of coded pulses) propagate trough and/or around a length of optical waveguide with a plurality of illuminating apertures and irradiate the optical pulses into the space at the predetermined direction and with predetermined time delays. The time delay between consecutive burst of pulse or pulse packet is determined by the optical path between the horizontally adjacent apertures (i.e., δt_{da}) in FIG. 5c and/or vertically adjacent in FIG. 5d (i.e. δt_{dp} wherein δt_{dp} stands for time delay between adjacent apertures in polar direction and it is more specifically refers to the situation of FIG. 5d.)
i. The speed of propagation of light in the guiding medium is extremely high and as the result the time for the electromagnetic beam to travel through the whole length of the optical waveguide in FIG. 5b, or FIG. 5c or 5d or 5e.a is extremely short. As the result of high propagation speed of light, the surrounding environment is illuminated with flashes of short optical pulses at an extremely high rate albeit one point (i.e. small area) of the space at a time. Accordingly we might as well call this mode of operation as “scanning flash mode of operation” or “Scanning Flesh LiDAR” (the quotation is to show the string of the words as one phrase and should not be interpreted as a direct quote from a source outside of this disclosure).
j. The detection and comprehension of the returned, echoed, signals in this mode is more complicated than other modes of operations that were previously disclosed. However, the advantage is that there is no moving part nor a need for complicated electronics to drive an array of two dimensional sources (e.g. as is the case in solid-State laser array LiDRAs) and or controlling the optical phases of the optical signals (as is the case for Optical Phase Array LiDRAs)
   In the scanning flash mode of operation we can have again two choices of designs and detection system:
   scan (or sweep flash) horizontally (azimuthal) direction first (e.g. see FIG. 5a-5c); OR
   scan (or sweep flash) vertically (polar) direction first.
a. Depends of the application and the environment and range that the remote sensing system, e.g. the LiDAR system of each of these configuration might be used or one configuration might be preferable.
b. However the operation and general processing concept of interpreting the returned signals according to the present invention will be in principal the same.
c. Furthermore, for implementing and deployment of the remote sensing of the present inventions there would be many variation of detector/detection systems configuration that one can envisioned and use. For instance in one embodiment a single directive detector system (directive as it detects the signal coming from certain direction/angles) might be used (e.g. if field of views are not large) or in another embodiment an array of directive detectors system might be used.

In here, according to one preferred embodiment of the present invention, we would like to have a single detection system which is omni-directional (or having a wide angle/s of reception) that can sense the incoming signals from large field of views and having a received Rₓ(t) signal as a function of time, which are basically the result of reflection of scanning flash signaling from the environments and can be shown as function of time as shown in FIG. 11a FIG. 11b, FIG. 12b, and FIG. 13c, and leave the job of object ranging and detection to an intelligent or advance signal/data processing module as will be explained in this and the later sections of this invention/s.

Again in this preferred embodiment (i.e. having single detection system) we can have few configurations that are going to be disclosed by way of exemplary embodiments as the followings:
a. SCANNING FLASH MODE AND SINGLE DTECION MODULE/SYSTEM WITH SINGLE PHOTOSENSITIVE DEVICE
   i. Ideally using one single detector system/module as, for instance, was shown in FIG. 9a-9b with one or more fast photosensitive device or a fast photodetector such APD (avalanche photodiodes) or photon multipliers, SPAD (single photon avalanche diode), etc. The detection system with its components and (e.g. the collection optic, the lens/es, filter/s, enclosure, etc) and sub-modules (e.g. the photosensitive device and it's the electrical parts) can exhibit an omni-directional detection system as explained before for the FIGS. 9a-9b.
   ii. In this case mapping the reflective objects positions only should be done with the illuminating signal timing (timing is also indicative of the direction an irradiated beam is propagating or targeting) which might be challenging since the reflected signal, depends on the objects in the surroundings, can arrive at the detector way out order (they won't come back at the time order as they been sent out).
   iii. In this case one way to make sense of the environment is that after each horizontal propagation (one round of azimuthal scan) we would have multiple reflections from at different time frames depending on eth range and the radial distance of the surrounding object.
   iv. By the detecting the reflected signal in a predefined time we would see that there reflection of objects from various places around the illuminating optics will form a function as time which extends far beyond the time of one horizontal round of illumination (δtₐᵣ−δt_{ex_ar}) which depends on the intended rage of detection for the sensing system.
   v. FIG. 11a, FIG. 11b, and FIG. 12a show exemplary signaling schemes and a transmitted signal as a function of time which is also corresponds to the propagation distance along the guiding medium of illuminating modules of FIG. 3a to FIG. 5d.
   vi. In FIG. 13a we show one signaling vs time for one round in one dimension. For instance FIG. 13a represent the illumination signals (e.g. pulse) either for one horizontals (azimuthal) round of FIGS. 5a-5c or one vertical line (polar direction) round of FIG. 5d. As an example let's consider only one round of horizontal illumination (as shown in FIG. 13a).
b. The choice of aperture arrangements can affect the quality and processing of the resultant LIDAR system. For example in the two dimensional aperture array of FIG. 5c, the beams travel first in the horizontal direction first and illuminate the horizontal field of view at each round of propagation (e.g., preferably a 360° field of view) and therefore the time difference between the horizontally adjacently illuminated beams is very short and one horizontally scanned round happens extremely quickly which might make it very challenging for the detector and the associated electronic system. That is because in this configuration and specially if we want to have a single detection system (preferable an omni-directional single detection device or module) then the time for reading the detected signal is extremely short which put a high demand on speed of the electronic system (e.g., the ADC clocked, dynamic range etc.

For comprehending the received signal to gain knowledge about the surroundings, we introduce have two approaches in comprehending the LiDAR system data of the present invention.
a. One approach is detailed observation using convolution of transmitted LiDAR signal and the received signal and reasoning and coming up with more rules for comprehending the environment.
b. The other approach is using investigation engine and intelligent investigation and reasoning.
c. So in FIG. 11 b, we can devise and algorithm to estimate the position of the surrounding object as the following:
   i. Convolving the Rx and Tx to obtain the convoluted signal as shown for example in FIG. 12c.
d. Accordingly, if such LiDAR using illumination apertures array of FIG. 5b or 5c is going to be used in vehicles then because the horizontal scanning round happened very quickly and furthermore, as is expected, a lot can happens in one round of horizontal scanning, the detection and the electronics not only must be very fast but also there arises some other complications as multiple reflection from different points of view (from really very different point of space around the LiDAR) arriving at the same time at the detector which make it even more challenging even for the intelligent comprehending module (as will be introduced and explained in the next section).
e. On the other hand in such application (application of LiDAR for assisting vehicles/robots to navigate in physical spaces) since the field of view of vertical (or polar field of view) is usually much narrower than the horizontal (or azimuthal) field of view. Furthermore in such applications the objects are localized with mostly limited height and continues. Accordingly, the vertical line scanning does not result in reflections that are widely disperse and or resulting in having reflected pulses arriving at the detector with very large arrival time variance. Moreover, meaningful or large enough delay lines can be inserted between each vertically alight apertures of FIG. 5d, so that o once a vertical line is scanned (a vertically scanned round) very fast and a bunch of reflected pulse arrived at a concentrated arrival time (with narrow arrival time variance) there would be a period of silence for illumination so that even a single detector can realize that one vertically scanned round has been done and most probably the next wave of the incoming reflected pulses (or photons) are coming from different angle/s of transmitted beams.
   Scanning Flash Mode with Single Dtection Module/System with Arrays of Photosensive Devices
i. The second choice of design for detection and recognition/comprehension is to have an array photosensitive devices for directive detection of returned echoes from fast scanning flash operation mode. In this option again, according to one preferred embodiment of present disclosure, we prefer to have a single optical system of detection but with many photosensitive devices for detecting defectively.
ii. FIGS. 9a and 9b for instance can used as optical system for collection and directing retuned signal onto photosensitive array of devices shown in FIG. 9c. According one exemplary embodiment of scanning flash operation mode with array of photosensitive detectors, each photosensitive device accompanies with its electronic to amplify the detected signal, digitize, and read its own data wherein a processing unit will gather the data from the individual detectors, and process the data in order to comprehend the returned signals, using various algorithms such as the one will be disclosed in the next section) from various directions and perhaps output other form of data set (e.g. point clouds, or image, etc.)
iii. In one embodiment detection system of FIG. 9c (comprising a plurality of photosensitive devices) can be fabricated by various technologies both discretely or integrate. For instance, the photosensitive devices of FIG. 9c can be fabricated with semiconductor manufacturing processes such silicon photonics or III-IV band gap materials, or any other suitable materials, by semiconductor manufacturing foundries over a single integrated chip. Furthermore, the associated electronic circuitry can also be integrated with the optical devices in principal.
iv. Those familiar with art can design and manufacture such detection system (using discrete component such as SMD (surface mounted device) methods or completely integrated) in order to build a LiDAR system with scanning flash operation mode as disclosed in the exemplary embayment/s of the present invention.

### Multiple or Array of Dtection

v. In this case several detection module can be use in parallel and configured to detect reflected signals based on their incoming direction or to provide redundancy so that even more data can be recorded to be used by the intelligent investigator to help to comprehend the surrounding as will be explained in the next sections.

### Dtection and Procesing

Fig. Shows one exemplary detected returned signal for one round of scan in the azimuth (e.g. the horizontal direction relative to the ground)

When there is a time discontinuity in the detected returned signal that means some objects at some direction are farther than previous reflected objects (which means, in fact, the previous reflective object would be to the left the farther object when the guided beam is propagating clockwise horizontally (relative to the ground when is observed from above, e.g. see FIG. 5c)

In one aspect we can have the transmitting signal as a function of time (FIG. 11b) where there is one to one correspondences between the time of irradiation (or otherwise time of light of the pulse burst/code from an aperture, say aperture number i) and the aperture id wherein each aperture is assigned with an id or in our terminology with a state component of predefined order and index (e.g. the i^{th} state component of order 1 which is referenced here as

$${SC}_{i}^{1}$$

which shows for instance the state of irradiation (e.g. on or off, or 1 and zero, or any number (real or complex)) of the aperture number i). Furthermore, there is one-to one correspondences between each aperture id and its illuminating beam direction of propagation in the surrounding space.

To uniquely identify the objects we can use the following pieces of information and/or approaches:

The time gap (the time that the returned signal is dropped or the received signal is silent,

The received combined detected a multipath in which a detected signal can be a result of receiving several reflections from different objects to the detector at the same time which might call it coincidental simultaneity,
investigating the returned signal layer by layer in radial direction by identifying the radius of the closed or nearest object detected and removing its contribution to the received signal and discover/find the radius of second closest/nearest object and removing its reelection contribution from the received signal and so on to at least gaining knowledge from radial distance of the surroundings objects,
combing the information of radial distances of the surrounding objects with the signaling and timing of illuminating temporal beams with the knowledge of their direction (from the time of irradiation and hence the id and hence the location/and hence the propagating direction of the illumining section (discrete or continues irradiation) and identify the object radial distance as well its directive angles or the coordinates of the detected objects,

Calculating the causal association between in the incident (the transmitted) or illuminating state components and the state components corresponding to the received signal (see section IX.I) wherein we have to calculate one or more of causal association strength between state components of transmitted and received signals to find the real causal association and to find the probabilities of knowing which part of the received signal is mostly to be due to a reflection of signal from which illuminating aperture or section of for instance FIG. 5c or 5d (i.e calculating

$$P ( {SC}_{i}^{1} \vert {SC}_{j}^{1} )$$

where

$${SC}_{i}^{1}$$

is the ith state component of order one and is corresponded to an illuminating state component whereas

$${SC}_{j}^{1}$$

is the jth state component of order one and is corresponded to a detected received signal at a certain detection devices,

One may further use neural network machine learning algorithms and system to have a trained detection system trained with a date-sets of present invention LiDAR systems and has become capable of giving the most probable information about the surrounding and the objects with their coordinates, and finally

Combination of one or more of the above information, and approaches.

So in one aspect we can have an illuminating signal Tₓ(t) as a function time, as shown in FIG. 11b, in which each pulse code time slot (i.e. the pulse burst) is corresponded to an aperture which again is corresponded to a direction (i.e. the azimuthal angle, ϕ, and polar angle, θ, in the spherical coordinate) of beam propagating into the cobranding space.

In with same aspect we can have, or show, the detected received signal as Rₓ(t) as a function of time, as shown in FIG. 11b. In here the radial distance is mapped into time axis and by knowing the exact timing an direction of the illuminating pulse from a identified aperture we can remonstrate the depth of view layer by layer in concentered circles with different radius. Because the sacking in horizontal is extremely quick in this configuration we can almost assume that echo of the objects in the same radial distance will arrive almost at the same time so when we have multiple burst of echo in time we can identify how many objects are in eth same radial distance and to find their exact coordinate we have to look more closely to the retuned signals at that bunch of echoes by comparing with the transmitted signal which is most likely to be responsible for those echoes (or reflection or returned signals).

According to another aspect of the present invention and by referring to FIG. 12.a to FIG. 12c now, here FIG. 12a shown an illuminating signal Tₓ(t) which is scan flashing the surrounding as a function of time and FIG. 12b shows a detected received signal as function of time Rₓ(t) whereas FIG. 12c shows the convolution of transmitted and received signal as the following:

$$C R T ( τ ) = {\int }_{0}^{Δ T} {T}_{x} ( τ - t ) {R}_{x} ( t ) d t ) .$$

wherein ΔT can be set to a desirable observation window. For instance, ΔT can be one or more rounds the time it takes for scanning flash signal, i.e. the pulse, to travel around the illuminating module in either vertical or horizontal direction or be as long as the light will take to travel to the maximum intended detection range and travel back to detection module, or reciprocal of the intended pulse reputation rate, or a video frame time, to any other time internal that is desired for instance to gather and assemble large data sets etc.

The convoluted signal carry many import and information and bear many import knowledge about the surroundings.

For instance, in some cases or embodiments of signaling, when there is an exact CRT at two different t then we can infers that there must have been a multiple reflections arriving at the same time. For another instance τ₁ give the next radial distance of nearest object and τ₂ give the previous further object. Suppose we know that the aperture i has fired and after τ₂ time we saw a big correlation (i.e. a big peak in the received signal or in the convoluted CRT(τ) and also we observed that when aperture i+k has fired and we see exact same peak in DRT(τ) after τ₁ then we can most probably infer that there is a multiple reflections from aperture i and aperture i+k however aperture i+k has fired kδt_{da} after aperture i therefore there must be an object that have been illuminated by aperture i but has arrived with the reflection from an object that have been illuminated by aperture i+k.

Moreover, one can notice that the Tₓ(t) is a constant deterministic function because the apertures or continues irradiation is deterministic and timing of the irradiation can be precisely calculated given eth guiding mediums of FIG. 5a-5e.d and its propagation speed of beam in that medium.

Accordingly convoluted signal CRT(τ) can be calculated rather fast by using the mathematical relationships between convoluted signals and their Furrier transform (e.g. the convolution result can be obtained by operating inverse Fourier transform of the multiplied Fourier transforms of the convoluting signals).

The Convoluted signal can be used in many different ways to interpret and calculate the range and coordinates of the surrounding objects with novel algorithms which might be different for each application or environment that the remote sensing system is going to be used.

For instance, the first instance that the convoluted signal (CRT(τ)) become none-zero (after disregarding noises and thresholding in detected signal) which is denoted by τ₀ in FIG. 12c, one can estimate the radial distance of the closest detected object of flash scanning, and as one move along the axis t one will bump into multiple peaks and valleys along the CRT(τ), it can be argued that peaks will be the results of multiple reflection from the different objects or angles receiving at the receiver/detector at the same time. Accordingly each peak in the convolution will be an indicative of next closest object since in this way we can estimate the radial distance of the objects in principal, Although we still might not know the exact coordinates of the reflective spot, however, we must pay attention that in the scanning flash mode of operation each area (or otherwise each distal object) of the surrounding space is scanned multiple times and therefore there recorded many data points corresponding to that area of space.

Having such dataset along with knowing the exact timing of irradiating pulses/beams and other clever design decisions one will become able to estimate the coordinates of the surrounding objects with high degree of accuracy.

For instance if delay time between each round in one dimension (e.g. delay time between each horizontal round of flash scanning) is noticeable (e.g. few nano-second of non-illumination period) then the returned signals would become even more interpretable even with one received signal as a function of time.

As mentioned before the choice of scanning order (e.g. horizontals first or vertical first) is also instrumental in making the job object recognition and ranging from one single deiced received signal much easier. For instance if the illuminating module of FIG. 5d is used (vertical scanning flash first) in here because the field of view is narrower and considerable delay time can be inserted between each scanning vertical flash then the detected signal is more likely to be even more obviously interpretable given. Furthermore, if the remote sensing is going to be designed for vehicle driving assistance applications, then we are most likely interested in rather close objects with limited height (e.g. max range of 300 meter and max height of 5 meter above the ground). Given the real physical objects, such as cars, pedestrians, trees and so one will give a rather continues reflection back to transmitter when they are scanned vertically, then interpreting the returned signal will become more manageable.

Referring to FIG. 13a-13d now, it will demonstrate another likely scenario of transmitted signal Tₓ(t) as function of time and the received signal Rₓ(t) to even more clearly visualize the operation of scanning flash mode of remote sensing system/s of the present invention. Shown in FIGS. 13a-13d the signaling that will be produced by the illuminating modules, i.e. the Tₓ(t), the reverse and shifted Tₓ(τ−t), the likely received signal Rₓ(t) and the possible and likely convoluted signal as function of time shift (τ). Obviously, it goes without mentioning that the same concept of detection can be used for directive detections (i.e., the detector that only looks at narrow field of view at least in one dimension) as well.

The signaling and the depictions in the FIG. 13a-13d, is more likely to be the case for illuminating module with vertical scanning first wherein the vertical field of view (e.g. 15°-25°) is usually much smaller than the horizontal field of view (e.g. 120-180-270-360°).

Again with the combination of the transmitted and received signal and their convolution and with many redundant echoed signals we can estimate the coordinates of the surrounding object and their shape and having a set of data presentative of the knowledge of the surroundings which can be further used to calculate point clouds or visualizing by rendering the resultant data into video steam.

It should be mentioned that the extreme case of using only one photosensitive device or having only one received detected signal might demand a considerable processing resources.

Accordingly to relax some of the constraint on the detection and processing system one might want to use a single detection system as a whole but with a plurality of directive detection units as shown in FIGS. 9c and 9d.

Said plurality of detection units could be comprised of an array of integrated photodiodes or an array of array of photosensitive devices fabricated over a substrate with a predestined pattern or geometrical relations to each other and can be manufactured/fabricated by variety of semiconductor manufacturing technologies as mentioned before.

Referring to 9a-9c and FIG. 9d again, and according to another embodiment of the present invention, we can have multiple directive detection system in which detection at each detector module (e.g. FIG. 9d) only looks at a designated direction in the surrounding space so as to the job of detection and ranging is divided between many independent detectors and wherein in this configuration or embodiment we now know about the direction of the incoming reflected signal and we should only infer the radial distance of different points of the relative object (a car in front LiDAR installed in or over a vehicle) in one direction only. The radial distance inference from a directly detected received signal would be much simpler since there is enough silence time between the burst of received signal and the probability of multiple reflections arriving at the same directive detector is much lower.

Moreover, on the challenge of how to separate and distinguish multiple reflection, we argue that there is causal association between the irradiating pulses which can be identified by a the specific time and direction which can be regarded as e.g., a 4D data point of a data set and later be represented by san state component of preassigned order as will be introduced in eth next section.

Therefore there must be an association that can be found between the irradiating state components and the state components corresponding to the reflected signal/s (as a 4D data point) which can be calculated by, for example, shifting and multiplying the coming signals as data arrays or vectors (e.g. a time series data array) or by convolving the transmitted and received signal/s as demonstrated in FIG. 11a to FIG. 13d.

a. Intellignet Recongintion of Objects and their Atributes

As eluded above, in one preferred embodiment and mode of operation we prefer to use a single detection system and ideally single detector (either using a single photo-sensitive or an array of photosensitive device on the same electro-optical chip).

In this exemplary preferred embodiment our detected signal (using one dimension or two dimension irradiating aperture arras) the detected signal eventually would be long data structures (e.g. a vector or matrix) which corresponds to the time of detection and reading and recording the detect signal which basically in its digital format a numerical array of very large dimension/s.

In one aspect, now we have a precisely predictable illuminating signaling as a function of time and a random like detected signal as a function of time as well (for the pre-specified length of time window, e.g., the whole steering flash time in both directions (azimuthal and polar). Each part of the detected signal is an indicative of an object in the surroundings.

Now we have to find at least three unknowns, the ϕ, the θ, and the r, of the object or the reflective spot. In other words we need to find or otherwise estimate the coordinates of the point in the surrounding space that has caused the reflected signal in a spherical coordinate with a pre-determined origin point (which could be set at any desirable point, e.g. geographical center of a vehicle or a point who's coordinates are frequently updated by having access to global position system and signaling, i.e., the GPS system). It is obvious that the spherical coordinate is selected for it's convince in such physical situations which involves radiation and propagation of electromagnetic waves into free space. Other coordinates (e.g. Cartesian, or polar) can be equally used for identifying the reflective point in the space or its coordinates be transformed to other forms as well.

Without restricting the scope of the invention, in one preferred embedment (e.g. any of FIG. 4a-4h, or 5a-5d) the irradiating pulse length (the pulse-width in second multiplied by the speed of light in the guiding medium) is shorter than distance between adjacent apertures. The adjacent apertures in the scanning mode of operation are adjacent in vertical direction and in the scanning flash mode are horizontally adjacent.

So in one aspect we consider that all we have are two signals as functions of time one of which with well or well pronounced signaling at the specified time and are deterministic and predictable (i.e., the transmitted signal over time) while the other one (the detected signal from one or more reflections) can be more complicatedly looking which in fact carries the information about the objects surrounding the illuminating source/s (e.g. the one or two dimensional irradiating aperture array/s).

If we can find a causal relationship between each part the incident (i.e., the transmitted) signal and the part/parts of the detect signal (which is as a result of reelection by distal objects) then we can identify the objects uniquely. That is partly because the deterministic signal (i.e. the transmitted signal as a function of time) carries the information about the propagation direction (i.e. the field of view of an irradiated beam from an aperture in FIG. 4-9) at each point of time.

This is where the intelligent investigator engine come into place, finding causal relationship between the incident beams (wherein each beam slightly deferred by time to the next beam, can be identified by their time of irradiation in the transmitted signal as a function of time) and the detected signal/s as result of reelection by a surroundings.

In the scanning mode the mechanical scanning can be done in time steps that allow enough time for a detector and the LIDAR processing system to process one vertical line scanned be finished until it will rotate another step to point at different angle of illumination (e.g. FIG. 4a-4e).

Accordingly, if we can find a bunching effect in a our received signal, especially in the mode of scanning flash vertically first, we can identify an object from eth bunch of returned detected signal and go to investigate inside the bunch to find more causal relationships between pieces of retuned signal and the transmitted signal.

FIGS. 11a to 13d show several methods of processing the detected data to recognize and find attributes of the objects of surrounding environment according to one exemplary embodiment of the present disclosure.

In the case that we would like to have very short optical pulses and/or very short adjacent apertures (e.g. very small δt_{da} or almost continues irradiation) and we cannot usually sample the retuned signal at extremely high speed. To cover this type of resolution we can have sampling rate of detected signal at lower speed than 1/δtₚ an then we can interpolate the sampled data to cover the high resolution which is needed. ADC of sampling rates of few Giga sample per (few GSPS) seconds are nowadays possible we can insert extra data by way of interpolating or averaging adjacent data points to increase the sampling rate or alternatively down sampling the transmitted signal if necessary in order have same size data arrays for the given period of time and therefore became able to straightforwardly perform the calculations (e.g. convolution, calculating causal associating data shifting and multiplication etc.) and processing the received and transmitted signals.

a. IX.I Data Gathering and Data Object Construction for Intellignet Investigaion of Remote Sensing System Data

In this section through exemplary embodiment and exemplary instantiations we show how to process the detected data in order to intelligently interpret and comprehend the surround environment with higher certainty and rigorous reasoning through investigation of the data set/s corresponding to the received signals by one or more detection module/subsystem.

The remote sensing system (e.g. the LiDAR systems according to the present invention or any other types of LiDAR and/or data producing, e.g. environmental data acquisition) will generate a large amount of data. For instance the detected received signals which are converted to electrical signal first and then after possible amplification will yet convert into digital form or digital data through Analogue to Digital convertors, ADC, (e.g. as shown in FIG. 9a-9c) at predetermined conversion rate (i.e. reading and conversion time clock by an ADC) to form one or more time series type of data arrays. Accordingly a data set comprising one or more digital data arrays as long vectors wherein, for example, the index of vector entries are corresponded to an instant of time, can be gathered or assembled that carry some information and knower about the surroundings of the remote sensing system or the LiDAR. Depends on the number of detectors and the number of such generated data arrays (time series data arrays) speed of the data reading/conversion clock rate and recording time the gathered data might become extremely huge.

According to one embodiment of the present invention, we introduce a comprehension module which we might call an intelligent compression module and/or an intelligent data investigator and/or a LiDAR data processing system form time to time.

Now we explain one or more preferred and exemplary methods of comprehending such large data set to acquire the knower desired to have from the objects and other attributes and parameters of the environment so as to assist a client. The client of comprehension or intelligent investigator or LiDAR data processor unit can be a visualising client, a reasoning engine client, a navigation system client, a human client, converting the data into natural text for human consumption or for conversation, or for aural output, and the so on).

In the US patent application with application Ser. No. 17/574,263 entitled “Methods and System for State Navigation” which is incorporated here as reference, we described the concept of participation of state components of different order into each other and how to form and/or construct and/or build data structures to represent participation of state components of different order into each other from which various types of associations including causal association can be derived and calculated. In particular it was disclosed that how one can find causal association between state component by shifting the occurrences (e.g., the sequence of their occurrence in time) and calculate the most probable cause of occurrence of one or more state component in the future time given the occurrence of one or more particular state components in the previous time (e.g. whether a particular aperture has fired or not at certain previous time and observing, for example the detected signal/s at later time).

Referring to FIG. 14a here, it shows an exemplary general illustration of participation matrix/s of state components of same or different orders representing by data structures that carries the participation information or data of state components of order k in the state components of order l, according to one exemplary embodiment of the present invention disclosure. Rows are corresponded to state component of order k wherein they can be corresponded or referring to or representing to groups of state components with order k but having the same or similar attribute/s (e.g. they can represent digitized and quantized values of certain measurable variable such the output of a photosensitive detector after ADC). The participation of state component of order k in the PM^{kl} is conveniently, but not necessarily, indicated by having binary value in the corresponding entry of the PM^{kl} (e.g. an entry of

$${pm}_{ij}^{kl}$$

in the ith row and jth columns of the PM^{kl}) as being present in the state component of order l in that column (e.g. at the moment of observation whether certain value of certain measurable which have been assigned as

$${SC}_{i}^{k}$$

was observed at the time of observation of states that is represented and assigned by state component order of l which is assigned with

$$S {C}_{j}^{l} ) .$$

In FIG. 14b there is shown one exemplary illustration of the building participation matrix corresponding to the participation of state components of interest into a higher order state components corresponding to the events taking place at different times (e.g. the state value of state component of first order in the set of state component at the time of sampling and/or readying the received echoes at the sampling time sampled at sampling rate speed, e.g., the highest speed at which the data is collected periodically, according to one exemplary embodiment of the present inventions' disclosure.

FIG. 14b, is in other words depicts a constructed participation matrix in which columns corresponds to state components of order l which is corresponded to state of a set of state components of order k at an instant of time wherein a set of state component of orders k are denoted by state components of order l. In this exemplary way of building the participation matrix of order kl (pm^{kl}) and wherein therefore a set of state components of order l are in fact an snapshots of state components of order k at different instant of time.

On the side note, and as example, it is noticed that in the context of LiDAR technology time and distance are intertwined and measurable so that knowing the timing an event (e.g., what is happening in

$${SC}_{j}^{l} )$$

can be translated to knowledge and info about radial distances as well.

As an example for further clarity an illustration lets review one exemplary of building a participation matrix (e.g., a PM¹³) for our remote sensing or LiDAR system according to an exemplary embodiment of the present invention.

First make a list (or a set) of desired state components of order 1.

For instance the detected signal at each one or more photosensitive device after amplification and recoding can be listed as list of possible values and regard each digitized value of a certain detector device or system as a state component of order one, 1, for instance. The values corresponded to a received detected signal by a detector system (e.g. FIG. 9c) could be normalized value according to a norm such as the average or maximum or length 1 or length 2 of anther vector such as previously recorded detected signal as a function of time or any other constant or normalising function in principal.

Then same for the list of apertures, if the illuminating module composed or comprised of radiating/irradiating apertures, for the directed illumination of sample illumination space. If the illuminating is continues and distributed (e.g. FIG. 5d) the list of view direction (e.g. the coordinates, ϕ and θ).

Therefore, for instance, if we want to cover the azimuth (or horizontal in some embodiment) field of view of 360° degree and we want to have a illumination at each degree in azimuth and want to have polar field of view (or vertical in some embodiments) of 30° and we would like to have, for instance, 128 points in polar direction then the state components of order one corresponding to illumination apertures (in the case discrete illumination eg. FIG. 5a-5b-5c) or sampled location of continues irradiation (e.g. FIG. 5d) with all possible and desired result ion would be 360×128=46080 which is the total number of state component of order one, 1, that are corresponded to or represent the sate components correspond to state of the illuminating module (i.e. the signal state of FIG. 10a 11a, 12a, 13a) and so on and for the detection system as well.

For everything else e can have a list of all desired state component of order one, 1.

Accordingly, for instance, we are going to have at most about 10⁵ number of SC¹ which are also are going to be the numbers of rows of the participation matrix of PM¹³. That is the ith column of PM¹³ is corresponded or representative of

$${SC}_{i}^{1} .$$

For the state component of higher order let's have a list of higher order SC and assign them with orders such 2, 3, 4, 5 and so on.

The SC³ in this exemplary algorithm or formulation are corresponded to state of state components of order one at the given or observed time.

Therefor each member of the sate component of SC³ is indeed a vector (in fact a tensor element to be technically correct) with dimension of equal to the size of the SC¹ set.

After building the SC¹ and SC³ sets then we are going to build or fill the entries of the participation matrix PM¹³, so that for each

$${SC}_{j}^{3}$$

vector we have a nonzero value for

$${pm}_{ij}^{13}$$

entry if

$${SC}_{i}^{1}$$

at the time of observing

$${SC}_{j}^{3}$$

and elze a zero entry.

In this exemplary illustration of building a participation matrix of order 1, 3, i.e. PM¹³, the columns of the PM¹³ are representative of state components of order 3. That is the jth column of PM¹³ is corresponded or representative of

$${SC}_{j}^{3} .$$

Depends on the speed of receiving or reading data intervals the number of columns the resulting PM could be a large number. For instance if observe the sate component of order 1 every 10 ps (i.e. 100 Giga sample/second) then for each second of observation we would have a matrix (participation matrix) with a dimension 10⁵ by 10¹¹ which is going to be a matrix with huge number of entries.

However, this participation matrix, the PM¹³ in our exemplary formulation or algorithm, is extremely sparse and therefore the storage needed to build and handle or manipulate such matrix is manageable in general.

Having constructed the PM^{3l} (in our example PM¹³) then we can proceed to calculate all types of derivative data objects such as a number of association and particularly causal association so as to extract and gain knowledge about the environment such as coordinates of distal objects points and other properties.

Referring to FIG. 14b now, it will further illustrate the PM matrix, its entries row, column and its implications. For instance in our example of building PM¹³ the column index are also can be regarded as presentative or corresponding to the time as well so that each row of the PM¹³ in our example is time dependent signal which can be operated one and specially in/by involving other rows (e.g. the signals) of other state component of order (e.g., a ith row of PM corresponding to the time behaviour of the state component

$${SC}_{i}^{1} ) .$$

When there are more than one detected signal that we are interested to have them recorded or saved then we can also make a PM for each detection device/system and having the PMs of each received and detected signal be concatenated, interleaved or stacked vertically and so on for further processing. In some embodiments according to the present invention (e.g., FIG. 5a to FIG. 5e,d and/or with the detector array of detector devices of FIGS. 9a-9c) our detector system will have more than one returned signal detection device or more than pone detected signal where in the signal conversation (reading and quantizing or ADC) to data can be done at lower speed and then be merged or interleaved with other detected signal to make a larger PM than an individual PM corresponding to a detector device.

Further, in some embodiments, having built/recorded the PM as master data resource. One can extract many type of information (such as speed (radial or lateral) noise, reflectivity size and possible recognition of the objects that are detected) and knowledge from this master data resource or matrix. Many smaller participation matrix can be carved out or harvested from the master PM as shown in FIG. 14 b.

Furthermore, more instrumental knowledge can be extracted from this master PM as disclosed in the U.S. patent application Ser. No. 17/574,263 entitles “Methods and Systems For State Navigation” such as contextual, causal, and effectual association strengths as well as predicting the most probable state components values in the future which can be provided to other clients such a control unit, a navigation unit etc.

a. IXX the Frequency Dependent Illumination Scheme and the Lidar'S Thereof.

Referring to FIG. 14 in here now, which shown an embodiment of FMCW LiDAR using self-frequency shift frequency modulation. As seen in this exemplary, yet simplified, embodiment there a continues wave laser source such as a DFB laser source (preferably with narrow linewidth) and an external modulator followed by a pulse compressor comprising an optical amplification and pulse compression module to produce short and powerful optical pulses and then send them through the illuminator which is for example can be comprising the illuminator embodiments of FIG. 5.e.a or more preferable FIG. 5e.c) wherein optical pulses experience self-frequency shift as they propagate, for instance, in core_1 of FIG. 5e.c/5.e.d, while also they irradiate a portion of their energy as they sweep/scan/steer the environment.

In this embodiment, since the frequency of the irradiating signal is an indicative of the direction of the irradiated beam then by coherent detection of a returned/reflected and measuring the frequency of the beat signal at the detector, one can uniquely identify the reflective object's location or coordinates. Moreover in this embodiment or mode of operation the irradiating frequency is also indicative of the time of flight of the irradiating signals which are also known values (or can be calculated analytically) which make the processing and calculations and/or estimation of coordinates more reliable and straightforward.

According to one embodiment of this disclosure the guiding medium can be imbedded in the front or rear vehicle transparent window so as to cover a narrower but a desired field of view in front or rear of a car or a vehicle without having to use other means of illumination support base or having a noticeable device on top or a part of car or vehicle.

FIG. 16 shows exemplary illustration of embodiments showing that continues irradiating guiding medium in embedded in a vehicle glass windows wherein the guiding medium can cause shift in the frequency of propagating pulse or wave while is also radiating as it propagate through the guiding medium.

While the timing of irradiation at each direction can be known very precisely the knowledge of the irradiating frequency will may have less certainty in this embodiment. In some embodiments for greater certainty, the irradiating frequency can also be dynamically estimated by measuring the entering/initial frequency of propagating beam and the peak power and/or the exiting frequency at the end of each frame scan (e.g. when the optical signal has reach the end of the coiled in FIG. 5e.a or 5e.b). Among the advantage of such methods of illumination, and signaling and detection of a LiDAR system of FIG. 14, is that the a distant/direction-dependent frequency modulated (e.g. the signal that experience frequency change without losing its integrity, e.g. soliton self-frequency shift) signal is sent out to the surrounding at a very fast rate wherein each point (or small region of space) is only exposed to a particular frequency or wavelength and the waiting time for receiving echo or reflections can be considerable (depends on the quality of the source laser, either CW with external modulation or producing optical pulse while lasing) and therefore such LiDAR's can be used in various range applications such as short range, ling ranges and ultra-long ranges.

It should be noted that even though the guided beam is temporal (i.e. time-dependent pulse) and each point of space is illuminated for the duration of the guided pulse only but, in this configuration, irradiation is continues although is changing its direction of propagation constantly and it is sweeping the field of views very fast. Accordingly there might not be enough time for the coherent detector to become able to detect the beating signals between the reflected signal and that of the reference signal since the reflected signal from a small area of the reflective object is in principal short lived (as short as the guided preparing pulse) but the hope is that the continues reflection from real object, which are usually large objects, make it possible for the coherent detector to measure the frequency of the reflected signal from eth object and hence its location.

If the coherent detection for this embodiment prove to be extremely challenging other ways of distinguishing the reflected wavelength (such as use of diffraction grating at the receiver to redirect the returned signal based on their wavelength into different direction in combination with an array of photosensitive devices) might be employed. Those skilled in the art can envision other variations and methods of estimating the wavelength of the returned signal in order to, consequently, become able to estimate the coordinates of the distal reflective objects.

Furthermore, according to another exemplary embodiment of the present invention the frequency shift can be constant and irradiates into surroundings through irradiating apertures at pre-determined location along the guiding medium or over the illuminating module (e.g. FIG. 5a-5d and any combination of them).

Moreover the guiding medium supporting pulse propagation and frequency shrift (e.g. nonlinear self-frequency shift) can itself be an active medium which compensate for the loss of pulse energy as they propagate and irradiates into the surroundings. The amount frequency change or shift along one round of illumination or one round of scanning flash mode can be changed by careful design of the guiding medium such as its dispersion and or nonlinearity coefficient, and/or its length and/or the inserted delay lines along the guiding medium of, for example, an illuminating module according to the teachings of the present invention.

### a. Summary

The disclosed frame work modules along with the algorithms and methods enables the people in building remote sensing systems and machines and more particularly machines and systems with autonomous navigation abilities in the desired space/s.

Since the disclosed underlying theory, methods and applications are universal it is worth to implement in the system of executing the methods and products directly on processing chips/devices to further increase the speed and reduce the cost of such investigations of compositions. In one instance, for example, the data processing operations (e.g. vector/matrix manipulations, manipulating data structures, association spectrums calculations and manipulation, etc.) and even storage of the data structures, is implemented with designs of Application Specific Integrated Circuits (ASICS), or Field-Programmable Gate Arrays, (FPGA), or the system-on-chip, based on any computing and data processing device manufacturing platforms and technologies, such as silicon based, III-IV semiconductors, and quantum computing artifacts to name a few. Similarly, if the disclosed methods of the investigation and applications are going to be used in/with implementing neural or cognitive based type of computations, still one can implement the system on such chips and by said technologies. Accordingly, those competent in the art can implement the disclosed methods for various applications/products in/with various data processing device manufacturing and designs on the physical material level.

Several desirable applications, systems, methods, and services also were exemplified to demonstrate the possible implementation and the possible applications and services. These exemplified applications, systems and services were given for illustration and exemplifications only and should not be construed as limiting the application. The invention has broad implication and application in many disciplines that were not mentioned or exemplified herein but in light of the present invention's concepts, algorithms, methods and teaching, they becomes apparent applications with their corresponding systems to those familiar with the art.

It is understood that the preferred or exemplary embodiments, the applications, and examples described herein are given to illustrate the principles of the invention and should not be construed as limiting its scope. Those familiar with the art can yet envision, alter, and use the methods and systems of this invention in various situations and for many other applications. Various modifications to the specific embodiments could be introduced by those skilled in the art without departing from the scope and spirit of the invention as set forth in the following claims.

What is claimed is:

1. A LiDAR system comprising:
at least one of an electronic system and a microwave system, to trigger to generate or initiate a master pulse generation to start signalizing,
an optical short pulse generator,
an optical system illuminating a designated area of space,
a detector and a data processing system to convert the returned pulses or received electromagnetic signals into digital data and to construct a data set comprising:
converting detected returned signal into digital,
assigning state component to one or more desired number of measurable quantities attributes,
assigning state component order on one or more groups of the state components,
building one or more data structures corresponding to participation of one or more sets of state components of different or the same order into each other, and
processing said one or more data structures to recognize objects or building cloud data points.

2. The LiDAR system of claim 1 further comprising methods to illuminate the designated area of space with train of electromagnetic pulses encapsulated in one or more pre-specified time frames.

3. The LiDAR System of claim 1 further comprising a burst of short optical pulses in picosecond or sub-picosecond ranges placed in a periodical time window, which is in turn placed in a predetermined cycle time frame.

4. The UDAR system of claim 1 further comprising producing pre-specified pulses in the predetermine time frame by propagating the electromagnetic pulses through an electromagnetic wave guiding medium which at least one the propagating properties of the guiding medium have been altered at predetermined locations along the guiding medium.

5. The Lidar system of claim 1 wherein the LiDAR signals, at the times of flight, have known geometrical coordinate and one or more the following parameters:
direction of propagating in space,
time of flight,
frequency of the radiating signal,
amplitude, and
polarization.

6. The LiDAR system of claim 4 wherein the frequency of illuminating beams or pulses are changed along the propagation length of the guiding medium.

7. The UDAR system of claim 1, wherein the optical pulses are optical solitons.

8. An illuminating module or system comprising a guiding medium, such as optical fibers or electromagnetic waveguide, for guiding electromagnetic wave, configured to have one or more apertures at predetermined locations of the guiding medium wherein the apertures are configured to provide a mechanism by which the confined propagating electromagnetic beam guided along the optical fiber or the waveguide will have an opportunity to radiate/irradiate away and leaking some energy of a guided beam of electromagnetic wave into space, outside of the guiding medium, at the designated locations so as to provide a plurality of electromagnetic wave beam sources.

9. The illuminating module of claim 8 wherein the guiding medium is coiled around a supporting structure.

10. The illuminating module of claim 8, wherein further configured to irradiate each of the plurality of the electromagnetic wave sources at the predetermined direction in the space.

11. The illuminating system of claim 8 wherein the guided beam is modulated in time so as to the irradiating beams also forms a train of pulses flying at pre-specified time and to provide an accurate time of flight.

12. The illuminating module of claim 8 wherein the guiding medium having one or more irradiating sections which irradiate continuously along the length of the irradiating sections so as to continually sweep and illuminate one or more areas of a surrounding environment as a propagating beam/pulse is sweeping through the desired field of view in one or more dimensions.

13. The illuminating module of claim 8 wherein the wavelength or frequency of the guided electromagnetic wave is changed as it propagate along the guiding medium.

14. The illuminating module of claim 8 wherein the guiding medium comprises one or more guiding cores wherein optical or geometrical characters of at least one of the cores is altered at predetermined locations.

15. The illuminating modules of claim 8 wherein either in the form of discrete radiating/irradiating apertures or continues irradiation, illuminate the surroundings in both field of view dimensions one spot at a time and as the beam is propagating through the illuminating module.

16. A remote sensing system comprising:
a pulse compressing to achieve optical pulse with desired pulse width and repetition,
encoding the pulse into a burst of optical pulses with a desired pattern,
an optical system to illuminate the environment with a method of illuminating comprising:
different time,
different azimuth angle, different radial angle, different z axis in polar coordinates,
and further comprising:
a length of waveguide with one or more irradiating apertures (to irradiate the environment) spread over one or more dimension in the space, or over a curved line in spherical coordinate and/or over a flat or curved surface,
one or more data processing units to investigate the received signals by the remote sensing system and output data that is going to be used by a client.

17. The remote sending system of claim 16 wherein the optical system for illumination comprises a guiding medium having exposer at predetermined locations along the guiding medium to partially irradiate energy of a guided propagating beam of electromagnetic wave into a space outside of propagating guided beam confinement.

18. The remote sensing system of claim 16 further comprising a ray collector optics comprising a curved reflector for deflecting incident ray of light into a target area.

19. The remote sensing system of claim 16 further compressing:
a plurality of optical detector to detect the returned optical system in one or more directions,
an electronic circuitry to digitize and record at least one the returned pulse, a burst of the returned pulses, and a train of returned pulses,
a data processing unit to process the digitized data to perform compressing:
building a plurality of sets of data from the digitized data from returned pulses each of sets having been assigned with state component order,
building data structures corresponding to participation of predefined state components of different order into other; and
processing the data structure to calculate the causal association of returned signals with at least one the returned signals and one of the illuminating signals.

20. The remote sensing system of claim 16, wherein further comprising data processing method for processing LiDAR data to convert the data to cloud points data for further visualization or rendering video frames from one or more LIDAR sensory data.
